(19) United States
(12) Patent Application Publication
(10) Pub. No.: US 2024/0314858 A1
(43) Pub. Date: Sep. 19, 2024

(54) ELECTRONIC DEVICE USING NETWORK SLICE, AND OPERATING METHOD

(71) Applicant: SAMSUNG ELECTRONICS CO., LTD., Suwon-si (KR)

(72) Inventors: Jinhyoung KIM, Suwon-si (KR); Sungin KIM, Suwon-si (KR); Taewan KIM, Suwon-si (KR); Wonbo LEE, Suwon-si (KR); Jaewon JANG, Suwon-si (KR)

(21) Appl. No.: 18/670,973

(22) Filed: May 22, 2024

Related U.S. Application Data
(63) Continuation of application No. PCT/KR2022/018245, filed on Nov. 17, 2022.

(30) Foreign Application Priority Data
Nov. 22, 2021 (KR) 10-2021-0161574

(51) Int. Cl. H04W 76/10; H04W 40/02

(52) U.S. Cl. CPC H04W 76/10; H04W 40/02

(57) ABSTRACT

According to various embodiments, an electronic device obtains a user equipment route selection policy (URSP) rule including at least one traffic descriptor and at least one route selection descriptor; identifies that a time identified by the electronic device and/or a place identified by the electronic device corresponds to first time information and/or first place information, included in a first route selection descriptor among the at least one route selection descriptor; provides a notification to a first application identified by a first traffic descriptor among the at least one traffic descriptor corresponding to the first route selection descriptor; and performs, based on identification of a network connection request from the first application that received the notification, at least one operation for establishing a protocol data unit (PDU) session based on the first route selection descriptor corresponding to the first application.

### CROSS-REFERENCE TO RELATED APPLICATIONS

This application is a continuation application, claiming priority under § 365(c), of an International application No. PCT/KR2022/018245, filed on Nov. 17, 2022, which is based on and claims the benefit of a Korean patent application number 10-2021-0161574, filed on Nov. 22, 2021, in the Korean Intellectual Property Office, the disclosure of each of which is incorporated by reference herein in its entirety.

### BACKGROUND

### Technical Field

Various embodiments relate to an electronic device using a network slice, and an operating method.

### Background Art

In order to meet wireless data traffic demands that have increased after 4G communication system commercialization, efforts have been made to develop an improved 5G communication system or a 6G communication system. For this reason, the 5G communication system or the 6G communication system is called a beyond 4G network communication system or a post-LTE system. In order to achieve a high data transmission rate, the 5G communication system is being implemented and serviced in an ultra-high frequency (mmWave) band (for example, 60 GHz band) and a sub-6 GHz band. In the 5G communication, in order to mitigate a propagation route loss at a higher frequency compared to the existing LTE and increase a propagation transmission distance, technologies, such as beamforming, massive MIMO, full dimensional MIMO (FD-MIMO), array antenna, analog beam-forming, and large scale antenna are being discussed in the 5G communication system.

A structural feature of a 5G network lies in adopting a network slicing technology for radio access network (RAN) and core network (CN) structures. This is intended for providing network resources and network functions by bundling up the network resources and the network functions into a single independent network slice depending on individual services, thereby applying attributes such as isolation, customization, and independent management and orchestration of network system functions and resources to a mobile communication network structure. The use of such a network slicing technology enables providing a 5G service in an independent and flexible manner by selecting and combining network functions of a 5G system according to references of services, users, and business models.

In a 3rd generation partnership project (3GPP), a user equipment (UE) route selection policy (URSP) rule is defined. A UE may receive a URSP rule from a policy control function (PCF), and form a network slice and a data session. The URSP rule may include a traffic descriptor and a route selection descriptor.

### SUMMARY

According to various embodiments, an electronic device may include at least one processor, and a memory connected electrically to the at least one processor and configured to store instructions executable by the at least one processor, wherein the instructions, when executed by the at least one processor, cause the electronic device to obtain a user equipment route selection policy (URSP) rule including at least one traffic descriptor and at least one route selection descriptor, identify that a time identified by the electronic device and/or a place identified by the electronic device corresponds to first time information and/or first place information included in a first route selection descriptor among the at least one route selection descriptor, provide a notification to a first application identified by a first traffic descriptor among the at least one traffic descriptor corresponding to the first route selection descriptor, and perform, based on identification of a network connection request from the first application that received the notification, at least one operation for establishing a protocol data unit (PDU) session based on the first route selection descriptor corresponding to the first application.

According to various embodiments, an operating method of an electronic device may include obtaining a URSP rule including at least one traffic descriptor and at least one route selection descriptor, identifying that a time identified by the electronic device and/or a place identified by the electronic device corresponds to first time information and/or first place information included in a first route selection descriptor among the at least one route selection descriptor, providing a notification to a first application identified by a first traffic descriptor corresponding to the first route selection descriptor, and performing, based on identification of a network connection request from the first application that received the notification, at least one operation for establishing a PDU session based on the first route selection descriptor corresponding to the first application.

According to various embodiments, an electronic device may include at least one processor and a memory connected electrically to the at least one processor and configured to store instructions executable by the at least one processor, wherein the instructions, when executed by the at least one processor, cause the electronic device to obtain a URSP rule including at least one traffic descriptor and at least one route selection descriptor, obtain a network connection request for an event from a first application, and based on first time information and/or first place information included in a first route selection descriptor among the at least one route selection descriptor corresponding to a time identified by the electronic device and/or a place identified by the electronic device, the first route selection descriptor corresponding to a first traffic descriptor among the at least one traffic descriptor identified based on information included in the network connection request, perform at least one operation for establishing a PDU session based on the first route selection descriptor.

According to various embodiments, an electronic device may include at least one processor and a memory connected electrically to the at least one processor and configured to store instructions executable by the at least one processor, wherein the instructions, when executed by the at least one processor, cause the electronic device to obtain a URSP rule including at least one traffic descriptor and at least one route selection descriptor, identify an inquiry from a first application, provide a response corresponding to the inquiry to the first application, based on first time information and/or first place information included in a first route selection descriptor among the at least one route selection descriptor corresponding to a time identified by the electronic device and/or a place identified by the electronic device, the first route selection descriptor corresponding to a first traffic descriptor among the at least one traffic descriptor identified based on information included in the inquiry, and based on identification of a network connection request from the first application that received the response, perform at least one operation for establishing a PDU session based on the first route selection descriptor corresponding to the first application.

### BRIEF DESCRIPTION OF THE DRAWINGS

FIG. 1 is a block diagram of an electronic device in a network environment, according to various embodiments.

FIG. 2A is a block diagram of an electronic device for supporting legacy network communication and 5G network communication, according to various embodiments.

FIG. 2B is a block diagram of an electronic device for supporting legacy network communication and 5G network communication, according to various embodiments.

FIG. 3A illustrates a 5G system structure.

FIG. 3B illustrates a 5G network slice structure.

FIG. 4A is a diagram illustrating a traffic allowance period according to various embodiments.

FIG. 4B is a diagram illustrating a PDU session between an electronic device and a network according to various embodiments.

FIG. 4C is a diagram illustrating PDU session establishment depending on a location of an electronic device according to various embodiments.

FIG. 5 is a flowchart illustrating an operating method of an electronic device according to various embodiments.

FIG. 6 is a diagram illustrating a configuration of an event table according to various embodiments.

FIG. 7 is a diagram illustrating an entity executing on an electronic device according to various embodiments.

FIG. 8 is a diagram illustrating an operation of an entity executing on an electronic device according to various embodiments.

FIG. 9A is a flowchart illustrating an operating method of an electronic device according to various embodiments.

FIG. 9B is a diagram illustrating a UI provided by an electronic device according to various embodiments.

FIG. 9C is a flowchart illustrating an operating method of an electronic device according to various embodiments.

FIG. 10 is a flowchart illustrating an operating method of an electronic device according to various embodiments.

FIG. 11 is a flowchart illustrating an operating method of an electronic device according to various embodiments.

FIG. 12 is a flowchart illustrating an operating method of an electronic device according to various embodiments.

FIG. 13 is a flowchart illustrating an operating method of an electronic device according to various embodiments.

FIG. 14 is a flowchart illustrating an operating method of an electronic device according to various embodiments.

FIG. 15 is a flowchart illustrating an operating method of an electronic device according to various embodiments.

FIG. 16 is a flowchart illustrating a PDU session established by an electronic device according to various embodiments.

FIG. 17 is a diagram illustrating an operation of an entity executing on an electronic device according to various embodiments.

FIG. 18 is a diagram illustrating an operation of an entity executing on an electronic device according to various embodiments.

FIG. 19A is a diagram illustrating an operation of an entity executing on an electronic device according to various embodiments.

FIG. 19B is a diagram illustrating a notification according to various embodiments.

FIG. 19C is a diagram illustrating an operating method of an electronic device according to various embodiments.

FIG. 20 is a diagram illustrating an operation of an entity executing on an electronic device according to various embodiments.

FIG. 21A is a flowchart illustrating an operating method of an electronic device according to various embodiments.

FIG. 21B is a flowchart illustrating an operating method of an electronic device according to various embodiments.

### DETAILED DESCRIPTION

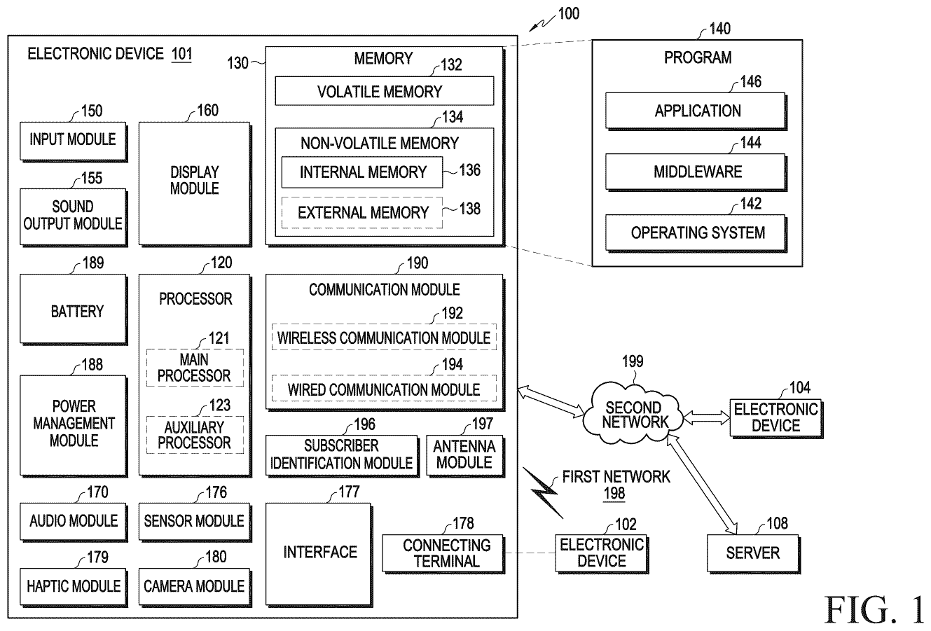

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to 3GPP's technical specification (TS) 24.526, a route selection descriptor may include time information (e.g., time window) and/or place information (e.g., location criteria) through which a protocol data unit (PDU) session may be effectively established. For example, a time window may refer to a time window in which matching traffic is allowed. For example, location criteria may refer to a location of a user device in which matching traffic is allowed. If identified time information and/or identified place information based on a network connection request (e.g., requestNetwork) from an application corresponds to the time information and/or the place information included in the route selection descriptor, the user device may perform an operation for establishing a PDU session based on a corresponding route selection descriptor. However, a route selection descriptor of a URSP rule is not provided to the application. Accordingly, for establishment of a corresponding PDU session, the application is required to provide a network connection request corresponding to time information and/or place information included in the route selection descriptor by chance, and therefore, the availability of the corresponding PDU session may be reduced.

According to various embodiments, in an electronic device and an operating method, when identified time information and/or identified place information corresponds to time information and/or place information included in a route selection descriptor, a notification may be provided to an application, and based on identification of a network connection request in response to the notification, at least one operation for establishing a PDU session may be performed.

Various embodiments may provide an electronic device and an operating method thereof, in which when identified time information and/or identified place information corresponds to time information and/or place information included in a route selection descriptor, a notification may be provided to an application, and based on identification of a network connection request in response to the notification, at least one operation for establishing a PDU session may be performed. Accordingly, the application may identify whether a condition for establishing a specific PDU session is satisfied, so that the specific PDU session can be established. The application may identify whether a condition for establishing a specific PDU session connectable at a specific time and/or location is satisfied, so that the specific PDU session to which the application desires to connect can be established.

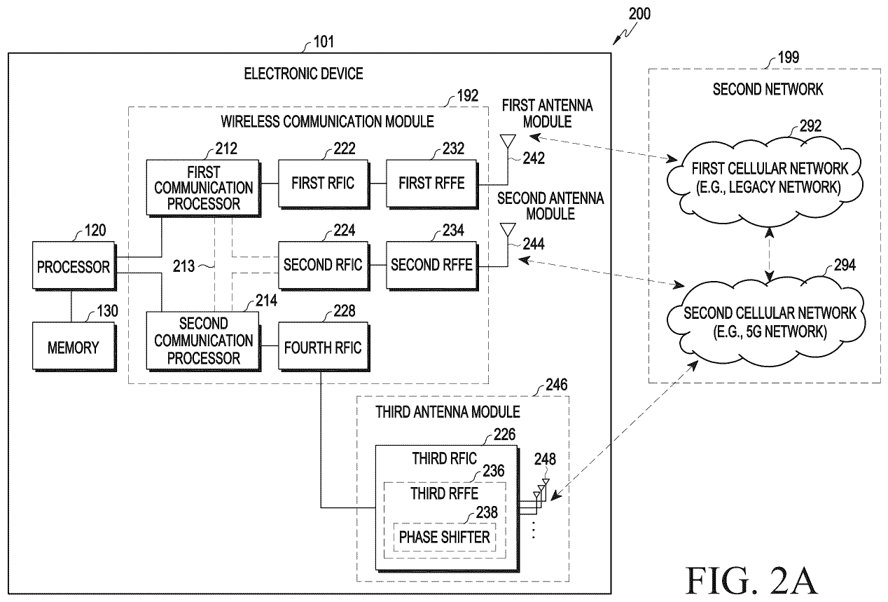

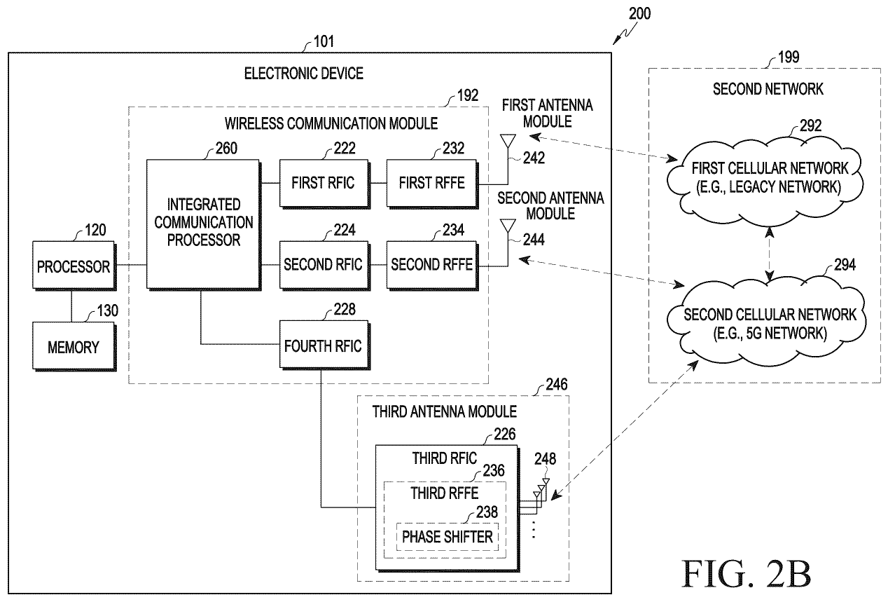

FIG. 2A is a block diagram 200 of the electronic device 101 for supporting legacy network communication and 5G network communication, according to various embodiments. Referring to FIG. 2A, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include the processor 120 and the memory 130. The second network 199 may include a first cellular network 292 (e.g., a legacy network) and a second cellular network 294 (e.g., a 5G network). According to another embodiment, the electronic device 101 may further include at least one of the components shown in FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least a part of the wireless communication module 192. According to another embodiment, the fourth RFIC 228 may be omitted or may be included as a part of the third RFIC 226.

The first communication processor 212 may establish a communication channel in a band to be used for wireless communication with the first cellular network 292, and support legacy network communication through the established communication channel. According to various embodiments, the first cellular network may be a legacy network including a second generation (2G), 3G, 4G, or long term evolution (LTE) network. The second communication processor 214 may establish a communication channel corresponding to a designated band (e.g., about 6 GHz to about 60 GHZ) among bands to be used for wireless communication with the second cellular network 294, and support 5G network communication through the established communication channel. According to various embodiments, the second cellular network 294 may be a 5G network defined by 3GPP. Additionally, according to an embodiment, the first communication processor 212 or the second communication processor 214 may establish a communication channel corresponding to another designated band (e.g., about 6 GHz or less) among bands to be used for wireless communication with the second cellular network 294, and support 5G network communication through the established communication channel.

The first communication processor 212 may transmit or receive data to or from the second communication processor 214. For example, data having been classified as being transmitted through the second cellular network 294 may be changed to being transmitted through the first cellular network 292. In this case, the first communication processor 212 may receive transmission data from the second communication processor 214. For example, the first communication processor 212 may transmit or receive data to or from the second communication processor 214 through an inter-processor interface 213. The inter-processor interface 213 may be implemented as, for example, a universal asynchronous receiver/transmitter (UART) (e.g., high speed-UART (HS-UART) or a peripheral component interconnect bus express (PCIe)) interface, but there is no limitation on the type thereof. Alternatively, the first communication processor 212 and the second communication processor 214 may exchange control information and packet data information by using, for example, shared memory. The first communication processor 212 may transmit or receive various information, such as sensing information, information on output intensity, and resource block (RB) allocation information, to or from the second communication processor 214.

Depending on the implementation, the first communication processor 212 may not be directly connected to the second communication processor 214. In this case, the first communication processor 212 may transmit or receive data to or from the second communication processor 214 through the processor 120 (e.g., an application processor). For example, the first communication processor 212 and the second communication processor 214 may transmit or receive data through the processor 120 (e.g., an application processor) and an HS-UART interface or a PCIe interface, but the type of interface is not limited. Alternatively, the first communication processor 212 and the second communication processor 214 may exchange control information and packet data information with the processor 120 (e.g., an application processor) by using shared memory.

According to an embodiment, the first communication processor 212 and the second communication processor 214 may be implemented in a single chip or a single package. According to various embodiments, the first communication processor 212 or the second communication processor 214 may be configured in a single chip or a single package with the processor 120, the auxiliary processor 123, or the communication module 190. For example, as shown in FIG. 2B, a communication processor 440 may support both functions for communication with the first cellular network 292 and the second cellular network 294.

At the time of transmission, the first RFIC 222 may convert a baseband signal generated by the first communication processor 212 to a radio frequency (RF) signal of about 700 MHz to about 3 GHz used for the first cellular network 292 (e.g., a legacy network). At the time of reception, an RF signal may be obtained from the first cellular network 292 (e.g., a legacy network) through an antenna (e.g., the first antenna module 242) and may be preprocessed through an RFFE (e.g., the first RFFE 232). The first RFIC 222 may convert the preprocessed RF signal to a baseband signal so as to be processed by the first communication processor 212.

At the time of transmission, the second RFIC 224 may convert a baseband signal generated by the first communication processor 212 or the second communication processor 214 to an RF signal (hereinafter, a 5G Sub6 RF signal) of a Sub6 band (e.g., about 6 GHz or less) used for the second cellular network 294 (e.g., a 5G network). At the time of reception, a 5G Sub6 RF signal may be obtained from the second cellular network 294 (e.g., a 5G network) through an antenna (e.g., the second antenna module 244) and may be preprocessed through an RFFE (e.g., the second RFFE 234). The second RFIC 224 may convert the preprocessed 5G Sub6 RE signal into a baseband signal so as to be processed by a corresponding communication processor among the first communication processor 212 or the second communication processor 214.

The third RFIC 226 may convert a baseband signal generated by the second communication processor 214 into an RF signal (hereinafter, referred to as a 5G Above6 RE signal) of a 5G Above6 band (e.g., about 6 GHz to about 60 GHZ) to be used for the second cellular network 294 (e.g., a 5G network). At the time of reception, a 5G Above6 RF signal may be obtained from the second cellular network 294 (e.g., a 5G network) through an antenna (e.g., the second antenna 248) and may be preprocessed through the third RFFE 236. The third RFIC 226 may convert the preprocessed 5G Above6 RE signal into a baseband signal so as to be processed by the second communication processor 214. According to an embodiment, the third RFFE 236 may be formed as a part of the third RFIC 226.

According to an embodiment, the electronic device 101 may include a fourth RFIC 228 separately from the third RFIC 226 or as at least a part of the third RFIC 226. In this case, the fourth RFIC 228 may convert a baseband signal generated by the second communication processor 214 into an RF signal (hereinafter, referred to as an IF signal) in an intermediate frequency band (e.g., about 9 GHz to about 11 GHZ), and then transmit the IF signal to the third RFIC 226. The third RFIC 226 may convert the IF signal into a 5G Above6 RF signal. At the time of reception, the 5G Above6 RF signal may be received from the second cellular network 294 (e.g., a 5G network) through an antenna (e.g., the antenna 248) and may be converted into the IF signal by the third RFIC 226. The fourth RFIC 228 may convert the IF signal into a baseband signal so as to be processed by the second communication processor 214.

According to an embodiment, the first RFIC 222 and the second RFIC 224 may be implemented as at least a part of a single package or a single chip. According to various embodiments, when the first RFIC 222 and the second RFIC 224 in FIG. 2A or 2B are implemented as a single chip or a single package, the same may be implemented as an integrated RFIC. In this case, the integrated RFIC may be connected to the first RFFE 232 and the second RFFE 234 to convert a baseband signal into a signal in a band supported by the first RFFE 232 and/or the second RFFE 234, and the converted signal may be transmitted to one of the first RFFE 232 and the second RFFE 234. According to an embodiment, the first RFFE 232 and the second RFFE 234 may be implemented as at least a part of a single package or a single chip. According to an embodiment, at least one of the first antenna module 242 or the second antenna module 244 may be omitted or combined with another antenna module to process RF signals of a plurality of corresponding bands.

According to an embodiment, the third RFIC 226 and the antenna 248 may be disposed on the same substrate to form the third antenna module 246. For example, the wireless communication module 192 or the processor 120 may be disposed on a first substrate (e.g., a main PCB). In this case, the third RFIC 226 may be disposed in a partial area (e.g., bottom) of a second substrate (e.g., a sub-PCB), which is separate from the first substrate, and the antenna 248 may be disposed in another partial area (e.g., top), so that the third antenna module 246 may be configured. By disposing the third RFIC 226 and the antenna 248 in the same substrate, a length of a transmission line therebetween can be reduced. This may reduce, for example, a loss (e.g., attenuation) of a signal of a high frequency band (e.g., about 6 GHz to about 60 GHZ) used in 5G network communication by a transmission line. Therefore, the electronic device 101 may improve the quality or speed of communication with the second cellular network 294 (e.g., a 5G network).

According to an embodiment, the antenna 248 may be formed as an antenna array including a plurality of antenna elements which may be used for beamforming. In this case, the third RFIC 226 may include, for example, as a part of the third RFFE 236, a plurality of phase shifters 238 corresponding to the plurality of antenna elements. At the time of transmission, each of the plurality of phase shifters 238 may convert a phase of a 5G Above6 RF signal to be transmitted to the outside (e.g., a base station for a 5G network) of the electronic device 101 through a corresponding antenna element. At the time of reception, each of the plurality of phase shifters 238 may convert the phase of the 5G Above6 RF signal received from the outside to the same phase or substantially the same phase through a corresponding antenna element. This enables transmission or reception through beamforming between the electronic device 101 and the outside.

The second cellular network 294 (e.g., a 5G network) may be operated (e.g., a stand-alone (SA)) independently of the first cellular network 292 (e.g., a legacy network) or may be operated (e.g., non-stand alone (NSA)) in connection with the first cellular network 292. For example, the 5G network may have only an access network (e.g., a 5G radio access network (RAN) or a next generation RAN (NR RAN)) and have no core network (e.g., a next generation core (NGC)). In this case, the electronic device 101 may access an external network (e.g., the Internet) under the control of a core network (e.g., an evolved packed core (EPC)) of the legacy network after accessing an access network of the 5G network. Protocol information (e.g., LTE protocol information) for communication with the legacy network or protocol information (e.g., new radio (NR) protocol information) for communication with the 5G network may be stored in memory 230 and accessed by another component (e.g., the processor 120, the first communication processor 212, or the second communication processor 214).

The processor 120, a communication processor (e.g., at least one of the first communication processor 212, the second communication processor 214, or an integrated communication processor 260) may be implemented as an integrated circuit, and in this case, may include at least one storage circuit configured to store at least one instruction that causes performance of an operation according to various embodiments and at least one processing circuit configured to execute the at least one instruction.

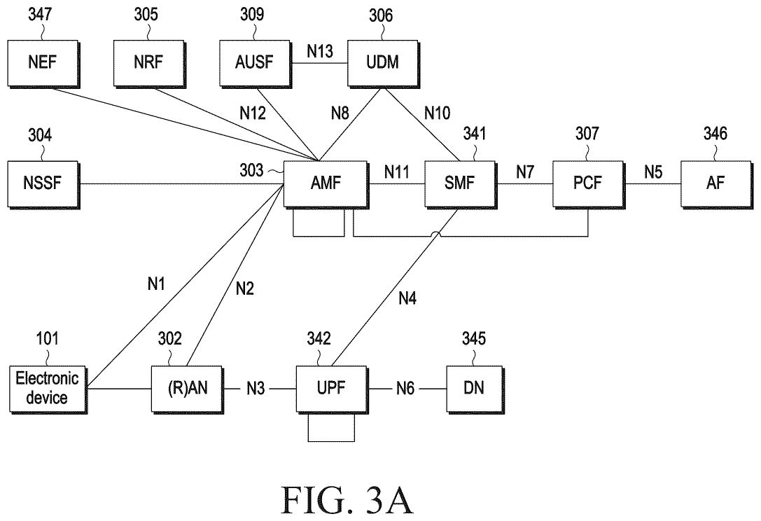

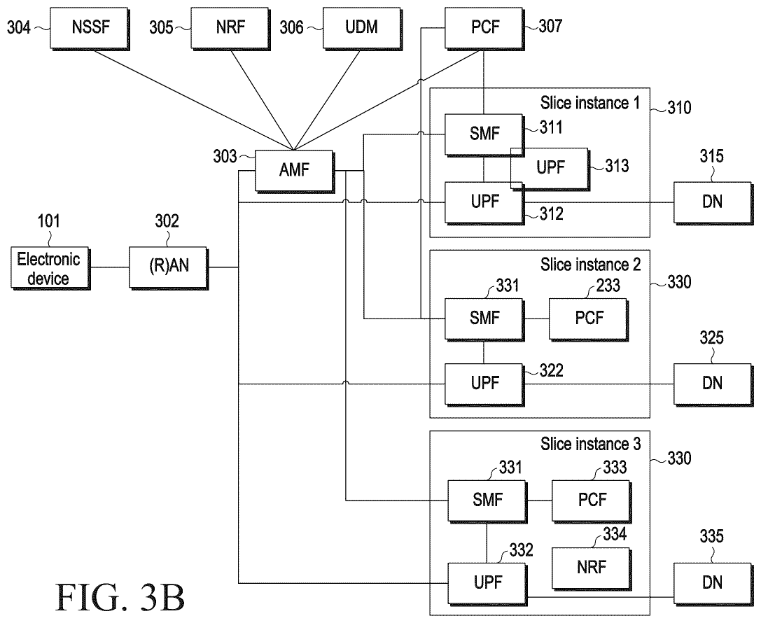

FIG. 3A illustrates a 5G system structure. FIG. 3B illustrates a 5G network slice structure. Hereinafter, the overall 5G system will be described with reference to FIGS. 3A and 3B and a network slice will be described.

As shown in FIG. 3A, a 5G system structure may include multiple network functions (NFs) within the electronic device 101 (e.g., a user equipment (UE)), a radio access network ((R)AN) 302, a data network (DN) 345, and a core network (CN) that are network elements.

In the 5G system structure, a function, a connection point, and a protocol may be defined for each of the NFs, and the 5G system structure may be described using a reference point representing a service-based interface corresponding to an NF and a reference point representing the interaction that exists between the NFs.

The multiple network functions (NFs) may include an authentication server function (AUSF) 309, an access and mobility management function (AMF) 303, a network exposure function (NEF) 347, a network function repository function (NRF) 305, a policy control function (PCF) 307, a session management function (SMF) 341, a unified data management (UDM) 306, a user plane function (UPF) 342, an application function (AF) 346, and a network slice selection function (NSSF) 304.

In various embodiments of the disclosure, the AMF, the SMF, the PCF, and the UPF may play a role in establishing a protocol data unit (PDU) (“UE-requested PDU”) session requested by a user device and managing traffic between the UE and the DN.

A reference point between the electronic device 101 and the AMF 303 is defined as N1.

The (R)AN 302 may represent a base station using radio access technology (RAT). For example, the AN 302 may be a base station which includes 3GPP access technology or a base station which includes non-3GPP access technology such as Wi-Fi. A reference point between the AN 302 and the AMF 303 is defined as N2, and a reference point between the AN and the UPF 342 is defined as N3.

The DN 345 may transmit a PDU to be transmitted in a downlink direction to the UPF 342, or receive a PDU transmitted by the electronic device 101 through the UPF 342. A reference point between the DN 345 and the UPF 342 is defined as N6.

The AMF 303 may provide an access and mobility management function independently of access technology, for example, in the unit of the electronic device 101. The reference point between the AMF 303 and the electronic device 101 is defined as N1, the reference point between the AMF 303 and the (R)AN 302 is defined as N2, a reference point between the AMF 303 and the UDM 306 is defined as N8, a reference point between the AMF 303 and the AUSF 309 is defined as N12, and a reference point between the AMF 303 and the SMF 341 is defined as N11.

The SMF 341 may provide a session management function in which, when one electronic device 101 has multiple sessions, a different SMF is allocated to each session to manage each session. The UPF 342 is configured using control signal information generated by the SMF 341, and the N4 reference point is defined so that the UPF 342 can report its status to the SMF 341. The reference point between the SMF 341 and the AMF 303 is defined as N11, a reference point between the SMF 341 and the UDM 306 is defined as N10, a reference point between the SMF 341 and the PCF 307 is defined as N7, and the reference point between the SMF 341 and the AMF 303 is defined as N11.

For example, while each electronic device 101 may be connected to one AMF 303, in the case of the SMF 341, one electronic device 101 may establish multiple sessions, and thus may have different SMFs 311, 321, and 331 for each session.

In order to ensure quality of service (QOS), the AF 346 may provide information on a packet flow to the PCF 307 in charge of policy control.

The PCF 307 may determine a policy such as session management and mobility management, based on the information on the packet flow for ensuring QoS, and transfer the same to the AMF 303 and the SMF 341, so as to perform at least one of appropriate mobility management, session management, and QoS management. A reference point between the AF 346 and the PCF 307 is defined as N5.

The AUSF 309 may store data for authentication of the electronic device 101.

The UDM 306 may store at least a part of a user's subscription data and policy data. A reference point between the AUSF 309 and the UDM 306 is defined as N13, the reference point between the AUSF 309 and the AMF 303 is defined as N12, the reference point between the UDM 306 and the AMF 303 is defined as N8, and the reference point between the UDM 306 and the SMF 341 is defined as N10.

CP functions include various functions to control a network and a terminal, and as two representative functions, the electronic device 101, the (R)AN 302, the UPF 342, the AMF 303, the AF 346, the DN 345 in charge of a mobility management function, and the SMF 341 in charge of a session management function may be included in the CP functions as two independent functions.

In describing embodiments of the disclosure, the terms “slice”, “service”, “network slice”, “network service”, “application slice”, and “application service” may be interchangeably used.

A mobile communication service provider may allocate a network resource appropriate for a corresponding service for each slice or for each set of a specific slice. The network resource may refer to at least one of a network function (NF) or logical resource or radio resource allocation provided by the network function NF.

Network slicing is a technology capable of providing network resources and network functions by bundling up the network resources and the network functions into a single independent slice depending on services, thereby allowing application of at least one attribute of resource isolation, customization, and independent management and orchestration to a mobile communication network structure.

Network slicing is a new concept for a 5G core network. The network slicing is a technology of providing network resources and network functions required for a service requested by a mobile terminal by bundling up the network resources and the network functions into a single independent slice.

Through the network slicing, a network service provider may independently allocate a network resource specialized for each service and user, and network flexibility through resource virtualization based on software defined networking (SDN) and network function virtualization (NFV) technologies is secured, so that scalability and reliability of service and network resource operation may be secured.

A public land mobile network (PLMN) may provide multiple network slices, and each of the network slices may be provided to a terminal in the form of a slice instance. For example, the PLMN may include slice instance 1 310, slice instance 2 320, and slice instance 3 330.

The electronic device 101 may access the network to receive a service from at least one of multiple slice instances simultaneously or sequentially.

Each slice instance may include network resources required to provide a corresponding network slice. For example, the slice instance 1 310 may include the SMF 311 and UPFs 312 and 313, the slice instance 2 320 may include the SMF 321, a UPF 322, and a PCF 323, and the slice instance 3 330 may include the SMF 331, a UPF 332, a PCF 333, and an NRF 334.

Referring to FIGS. 3A and 3B, the SMF 321 of the slice instance 2 320 may be connected to the PCF 307 of a PLMN level and the PCF 323 of a slice level. The PCF 307 of the PLMN level may manage policy information about the PLMN level and provide the same to the SMF 321. The PCF 323 of the slice level belonging to the slice instance 2 may manage a policy required to provide the corresponding slice, and may provide the corresponding information to the SMF 321.

Each slice may be distinguished by a slice ID. As an example, the slice ID may be single-network slice selection assistance information (S-NSSAI) defined by the 3GPP. According to various embodiments, the electronic device 101 may store information on configured network slice selection assistance information (configured NSSAI) and a network slice selection policy (NSSP). The configured network slice selection assistance information (configured NSSAI) may consist of a list of S-NSSAI of network slices to which the electronic device 101 has subscribed to a home PLMN (HPLMN). The list of S-NASSAI may include at least one S-NSSAI #id. For example, the list of S-NASSAI may include S-NASSAI #a, S-NASSAI #b, S-NASSAI #c, and S-NASSAI #d. Since the configured NSSAI is determined based on subscription information of the electronic device 101, the S-NSSAI constituting the configured NSSAI may differ for each electronic device 101. In addition, since the configured NSSAI is determined based on the subscription information of the electronic device 101, if the subscription information of the electronic device 101 is changed, the configured NSSAI stored in the electronic device 101 may also be changed. The list of S-NSSAI to which the electronic device 101 has subscribed and which constitutes the configured NSSAI may be stored in the integrated UDM 306 which stores the subscription information of the electronic device 101. The S-NSSAI to which the electronic device 101 has subscribed and which is stored in the UDM 306 may be called “Subscribed S-NSSAI”. The network slice selection policy (NSSP) indicates mapping information between the S-NSSAI (S-NSSAI #id) to which the electronic device 101 has subscribed and an application that the corresponding S-NSSAI can support. One S-NSSAI #id may be mapped to at least one application. For example, S-NASSAI #a may be mapped to App #1 and App #2, S-NASSAI #b may be mapped to App #1, S-NASSAI #c may be mapped to App #3, and S-NASSAI #may be mapped to all supportable applications. The NSSP may be stored in a policy control function (PCF) of storing policy information related to the electronic device 101 and the network. Alternatively, the NSSP may be stored in a user data repository (UDR), and the PCF may request NSSP information from the UDR, if necessary, so as to obtain the NSSP information from the UDR. When there is a change in the subscription information of the electronic device 101, subscription slice (subscribed S-NSSAIs) information of the electronic device 101 stored in the UDM 306 may be changed. When there is a change in the subscription information of the electronic device 101, the NSSP information stored in the PCF or the UDR may be changed. If at least one of the subscription slice (subscribed S-NSSAIs) or the NSSP is changed, relevant configuration information stored in the electronic device 101 may also need to be updated.

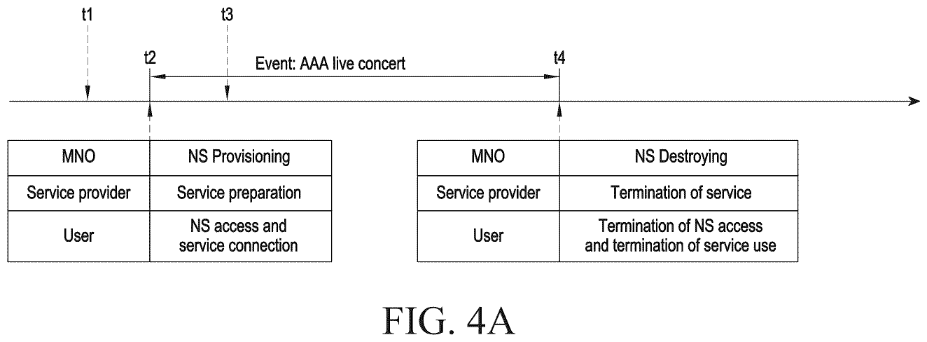

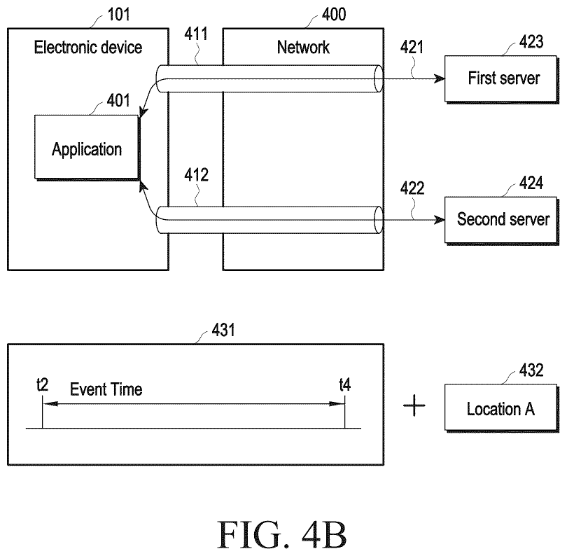

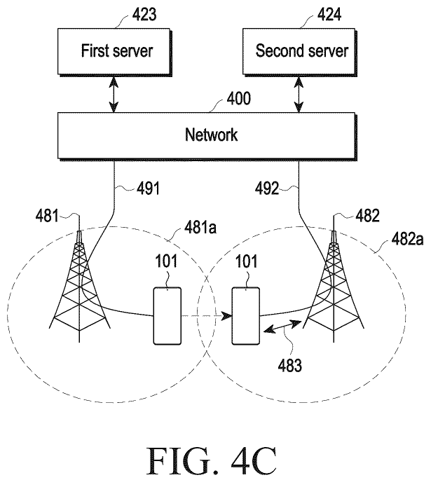

FIG. 4A is a diagram illustrating a traffic allowance period according to various embodiments. The embodiment of FIG. 4A will be described with reference to FIG. 4B. FIG. 4B is a diagram illustrating a PDU session between an electronic device and a network according to various embodiments.

According to various embodiments, the electronic device 101 (e.g., at least a part of the processor 120, the first communication processor 212, the second communication processor 214, or the integrated communication processor 260) may obtain a URSP rule as shown in Table 1 from, for example, a network (e.g., a PCF). It should be appreciated that the rules shown in Table 1 are merely examples and that other rules are possible in other embodiments.

TABLE 1

| Rule | Rule | Traffic | |
|---|---|---|---|
| number | precedence | descriptor | Route selection descriptor |
| 1 | 1 | App | Precedence = 1 S-NSSAI = 101 |
| | | Descriptor = | SSC Mode = 2 |
| | | AppID1 | |
| 2 | 2 | App | [RSD(route selection descriptor) I] |
| | | Descriptor = | Precedence = 1 |
| | | AppID1 | S-NSSAI = 102, SSC Mode = 2 |
| | | | Time Window = TimeVal_a1~ |
| | | | TimeVal_a2 |
| | | | Location Criteria = Location_a |
| | | | [RSD 2] |
| | | | Precedence = 2 |
| | | | S-NSSAI = 103, DNN = |
| | | | internet.mno.com |
| | | | SSC Mode = 1 |
| | | | Time Window = TimeVal_b1~ |
| | | | TimeVal_b2 |
| | | | Location Criteria = Location_b |
| 3 | 3 | * (match all) | Precedence = 1 |
| | | | S-NSSAI = 1 |
| | | | DNN = internet.mno2.com |

Referring to Table 1, in rule number “1” of the URSP rule, a traffic descriptor may include information indicating that an application descriptor (App Descriptor) is AppID1, and a route selection descriptor may include information indicating that precedence is 1, S-NSSAI is 101, and an SSC mode is 2. For example, if a network connection request (e.g., requestNetwork) is identified from an application of AppID1, the electronic device 101 may perform at least one operation for establishing a PDU session by using the route selection descriptor of the URSP rule with rule number “1”. In rule number “2” of the URSP rule, the traffic descriptor may include information indicating that the application descriptor is AppID2. In rule number “3” of the URSP rule, the traffic descriptor may include information indicating that the application descriptor is not limited (e.g., match all), and the route selection descriptor may include information indicating that precedence is 1, S-NSSAI is 1, and DNN is internet.mno2.com. For example, if a network connection request is identified from an application which does not correspond to the traffic descriptor of rule number “1” and rule number “2”, the electronic device 101 may perform at least one operation for establishing a PDU session by using the route selection descriptor of the URSP rule with rule number “3”. In response to one traffic descriptor, multiple (e.g., two) route selection descriptors (e.g., RSD1 and RSD2) may be configured. One route selection descriptor (e.g., RSD1) may include information indicating that time information (e.g., Time Window) is a first time point (e.g., TimeVal_a1) to a second time point (e.g., TimeVal_a2) and place information (e.g., Location Criteria) is a first point (e.g., Location_a) together with information that precedence is 1, S-NSSAI is 102, and an SSC mode is 2. Another route selection descriptor (e.g., RSD2) may include information indicating that time information (e.g., Time Window) is a third time point (e.g., TimeVal_b1) to a fourth time point (e.g., TimeVal_b2), and place information (e.g., Location Criteria) is a second point (e.g., Location_b) together with information that precedence is 2, S-NSSAI is 103, DNN is internet.mno.com, and an SSC mode is 1. The time information (e.g., Time Window) in the example may be expressed in a 64-bit NTP timestamp format, but there is no limitation on an expression format. The place information (e.g., Location Criteria) in the example may be expressed as tacking area (TA) and/or cell information, but there is no limitation in an expression format. For example, if one route selection descriptor (e.g., RSD1) includes time information and/or place information, another route selection descriptor (e.g., RSD2) may also be required to include the time information and/or the place information. The electronic device 101 may identify current time information and/or current place information, and if the identified time information and/or the identified place information corresponds to the time information and/or the place information included in the route selection descriptor, identify that the corresponding URSP rule is valid. If the identified time information and/or the identified place information does not correspond to the time information and/or the place information included in the route selection descriptor, the electronic device 101 may identify that the corresponding URSP rule is invalid.

For example, referring to FIGS. 4A and 4B, time point t2 to time point t4 may be time information (e.g., Time Window) 431 included in the route selection descriptor of the URSP rule. In addition, a place of location A may be place information (e.g., location criteria) 432 included in the route selection descriptor of the URSP rule. For example, a corresponding PDU session 412 (or network slice) may be configured for a specific event (e.g., an AAA live concert) according to an agreement between a mobile network operator (MNO) and a service provider. A network entity (e.g., PCF) corresponding to the MNO may share the URSP rule according to the corresponding agreement with user devices. At time point t2, the MNO may be required to perform provisioning of the network slice, the service provider may be required to prepare a service, and a user may be required to access the network slice and connect to the service. The electronic device 101 may identify that the corresponding URSP rule is valid during a period from time point t2 to time point t4, and may identify that the corresponding URSP rule is invalid during a period other than the period from time point t2 to time point t4 (e.g., before time point t2 or after time point t4). Those skilled in the art will understand that this assumes that a condition associated with place information is satisfied. At time point t4, the MNO may be required to perform destroying of the network slice, the service provider may be required to terminate the service, and the user may be required to terminate the network slice access and terminate the use of the service.

For example, when an application provides a network connection request at time point t3 which is included in a period from time point t2 to time point t4, the electronic device 101 may identify that the URSP rule is valid at a time point of identifying the network connection request, and establish the PDU session 412 based on the route selection descriptor of the corresponding URSP rule. Accordingly, the electronic device 101 may transmit and/or receive traffic 422 to and/or from a second server 424 by using the PDU session 412 specifically configured in response to a corresponding event. When the application provides a network connection request at time point t1 which is included in a period other than the period from time point t2 to time point t4, the electronic device 101 may identify that the URSP rule is invalid at a time point of identifying the network connection request. In this case, the electronic device 101 may establish a PDU session 411, based on a route selection descriptor of another valid URSP rule, and transmit and/or receive traffic 421 to and/or from a first server 423 by using the PDU session 411. For example, the first server 423 corresponding to the PDU session 411 and the second server 424 corresponding to the PDU session 412 may be configured for one application 401. In FIG. 4B, the first server 423 and the second server 424 are represented as different entities, but this is illustrative, and the first server 423 and the second server 424 may be physically separated entities, or may be logically separated servers within one physical entity, and may be implemented as one server in some cases. Accordingly, the electronic device 101 may not be able to use the PDU session 412 specially configured in response to a corresponding event. If information indicating that the URSP rule is valid, or information related to the validity of the URSP rule (e.g., time information and/or place information of the route selection descriptor) is not transmitted to the application in advance, it cannot be guaranteed that the application is to provide a network connection request during a period from time point t2 to time point t4. The electronic device 101 according to various embodiments may provide, based on satisfaction of a condition associated with the time information and/or the place information included in the URSP rule, a notification relating thereto to the application, and may establish a PDU session if the network connection request is identified from the application in response thereto.

FIG. 4C is a diagram illustrating PDU session establishment depending on a location of an electronic device according to various embodiments.

According to various embodiments, the electronic device 101 (e.g., at least a part of the processor 120, the first communication processor 212, the second communication processor 214, or the integrated communication processor 260) may be located within a coverage 481a of a first cell 481 and may connect to the first cell 481. The electronic device 101 may establish a first PDU session 491 with a network 400 in a state of being connected to the first cell 481. For convenience of description, the first cell 481 (e.g., RU) is shown as not being a part of the network 400, but this is only for illustration purposes, and those skilled in the art will understand that the first cell 481 may also constitute at least a part of the network 400. The electronic device 101 may establish the first PDU session 491, based on the highest priority URSP rule among at least one valid URSP rule in a state of being connected to the first cell 481. The electronic device 101 may transmit and/or receive traffic to and/or from the first server 423 through the first PDU session 491. The electronic device 101 may move within a coverage 482a of a second cell 482. The electronic device 101 may perform at least one procedure for handover from the first cell 481 to the second cell 482, and thus may connect to the second cell 482. The electronic device 101 may identify that place information associated with the second cell 482 corresponds to the place information of the route selection descriptor of the URSP rule. The electronic device 101 may provide a notification to an application corresponding to the route selection descriptor of the corresponding place information. Those skilled in the art will understand that, when the route selection descriptor of the URSP rule further includes time information in addition to place information, it is assumed that a condition associated with time information is also satisfied. The electronic device 101 may establish a second PDU session 492 based on the corresponding URSP rule, based on identification of a network connection request corresponding to the notification. The electronic device 101 may transmit and/or receive traffic to and/or from the second server 424 through the second PDU session 492. Accordingly, the electronic device 101 may transmit and/or receive traffic by using the second PDU session 492 specially configured at a specific place (e.g., connect to a specific cell and/or located in a specific TA). The electronic device 101 may provide the notification for the application and establish a PDU session based on a network connection request as a response to the notification, thereby reducing the possibility of missing establishment of the second PDU session at a specific place.

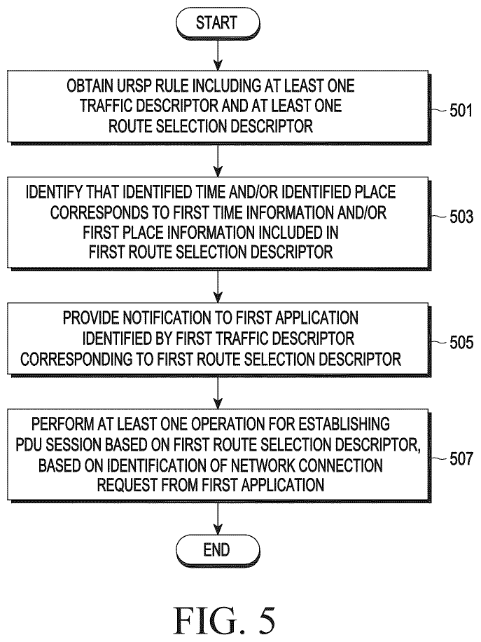

FIG. 5 is a flowchart illustrating an operating method of an electronic device according to various embodiments.

According to various embodiments, in operation 501, the electronic device 101 (e.g., at least a part of the processor 120, the first communication processor 212, the second communication processor 214, or the integrated communication processor 260) may obtain a URSP rule including at least one traffic descriptor and at least one route selection descriptor. In operation 503, the electronic device 101 may identify that an identified time and/or an identified place corresponds to first time information and/or first place information included in a first route selection descriptor among the at least one route selection descriptor. For example, if the first time information included in the first route selection descriptor corresponds to a period from time point t1 to time point t2, and a time identified as the current time corresponds to time point t3, time point t3 is included within the period from time point t1 to time point t2, and thus the electronic device 101 may identify that the identified time corresponds to the first time information included in the first route selection descriptor. If time point t3 is not included within the period from time point t1 to time point t2, the electronic device 101 may identify that the identified time does not correspond to the first time information included in the first route selection descriptor. For example, if the first place information included in the first route selection descriptor is first cell identification information, since identification information of a cell to which the electronic device 101 is currently connected is the first cell identification information, the electronic device 101 may identify that the identified place corresponds to the first place information included in the first route selection descriptor. If the identification information of the cell to which the electronic device 101 is currently connected is not the first cell identification information, the electronic device 101 may identify that the identified place does not correspond to the first place information included in the first route selection descriptor. For example, if the first place information included in the first route selection descriptor is a first TA, since a TA in which the electronic device 101 is currently included is the first TA, the electronic device 101 may identify that the identified place corresponds to the first place information included in the first route selection descriptor. If the TA in which the electronic device 101 is currently included is not the first TA, the electronic device 101 may identify that the identified place does not correspond to the first place information included in the first route selection descriptor.

According to various embodiments, in operation 505, the electronic device 101 may provide a notification to a first application (e.g., the application 401) identified by a first traffic descriptor corresponding to the first route selection descriptor. For example, the first traffic descriptor may include an AppID, and the electronic device 101 may identify the first application by using the AppID. The notification may include, for example, at least a part of information (e.g., an application descriptor, an Internet protocol (IP) descriptor, a domain descriptor (e.g., a fully qualified domain name (FQDN)), a non-IP descriptor, a data network name (DNN), and connection capabilities) included in the first traffic descriptor, but is not limited thereto. The manner of providing the notification to the first application may be, for example, an IPC-based manner, a callback-based manner, a socket-based manner, an Intent-based manner, or a message-based manner, but those skilled in the art will understand that there is no limitation to the type thereof. In operation 507, the electronic device 101 may perform, based on identification of a network connection request from the first application, at least one operation for establishing a PDU session based on the first route selection descriptor. In an example, an application may be configured to provide a network connection request in response to receiving a notification. In this case, the application may not require an additional event other than receiving the notification in order to provide the network connection request. In another example, the application may be configured to provide a UI for a user input in response to receiving a notification, or to request another entity (e.g., a notification manager) to provide the UI. If an input from a user based on the UI is identified, the application may provide a network connection request. For example, the network connection request may include at least a part of information included in the notification. In the above example, since the notification may include at least a part of the information included in the first traffic descriptor, the network connection request may include at least a part of the information included in the first traffic descriptor. At least one operation for establishing a PDU session, as will be described later, may include, for example, transmitting at least a PDU session establishment request message and receiving a PDU session establishment accept message.

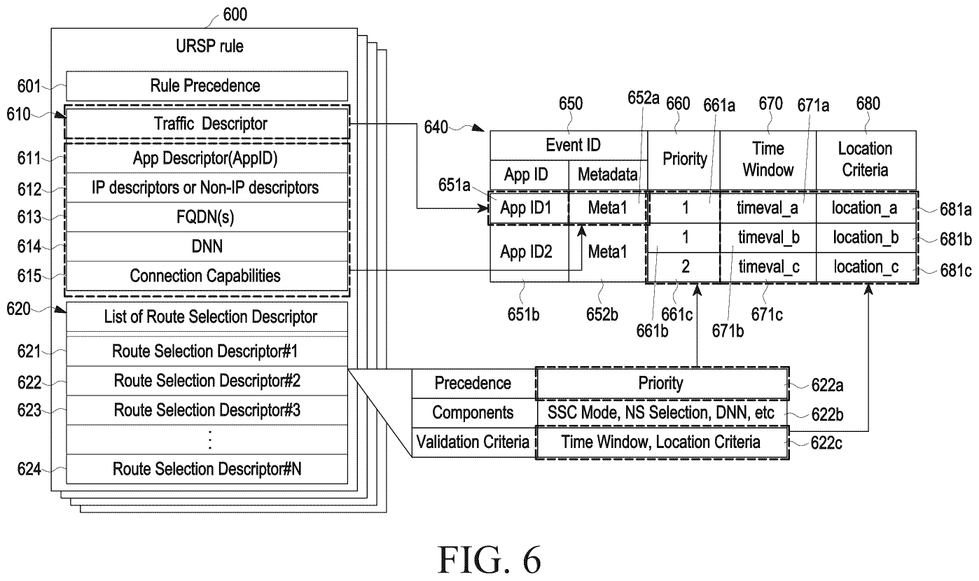

FIG. 6 is a diagram illustrating a configuration of an event table according to various embodiments.

According to various embodiments, the electronic device 101 (e.g., at least a part of the processor 120, the first communication processor 212, the second communication processor 214, or the integrated communication processor 260) may obtain a URSP rule 600 from, for example, a network. The URSP rule 600 may include rule precedence 601, a traffic descriptor 610, and a route selection descriptor list 620. The traffic descriptor 610 may include an application descriptor (e.g., AppID) 611, an IP descriptor or non-IP descriptor 612, FQDN(s) 613, a DNN 614, and connection capabilities 615. An AppID 611 is an ID for distinguishing an App from an OS and a service provider, and may be configured based on OS information and/or App package information, but is not limited thereto. The route selection descriptor list 620 may include a plurality of route selection descriptors 621, 622, 623, and 624. For example, one route selection descriptor 622 may include precedence 622a of “Priority”, components 622b of “SCC mode”, “NS selection”, and a DNN, and validation criteria 622c of Time Window and Location Criteria.

According to various embodiments, the electronic device 101 may configure an event table 640 based on the URSP rule 600. The event table 640 may include an event identifier (Event ID) 650. The event identifier 650 may include, for example, an application descriptor (e.g., AppID) and metadata. The metadata may include at least a part of the remaining information excluding the application descriptor among traffic descriptors. For example, in one of the traffic descriptors, AppID1 and the remaining information may be stored to correspond to each other, and the electronic device 101 may configure a first event ID by associating AppID1 651a and Metal 652a based on the corresponding traffic descriptor. The Metal 652a may include at least a part of the remaining information of the traffic descriptors. For example, in one of the other traffic descriptors, AppID2 and the remaining information may be stored to correspond to each other, and the electronic device 101 may configure a second event ID by associating AppID2 651b and Metal 652b based on the other traffic descriptors. The Metal 652b may include at least a part of the remaining information of the other traffic descriptors, and in the example of FIG. 6, metadata of the first event ID and metadata of the second event ID are described as being the same, but this is an example and may differ.

According to various embodiments, the electronic device 101 may configure priority 660 of the event table 640, based on a priority of the route selection descriptor. A value 661a, 661b, or 661c of the priority 660 of the event table 640 may be a value corresponding to each traffic descriptor. In the example of FIG. 6, in the URSP rule 600, two route selection descriptors may correspond to a traffic descriptor including AppID2 651b. Accordingly, two priorities 661b and 661c may correspond to the second event ID corresponding to the AppId2 651b. The electronic device 101 may configure time information 670 of the event table 640, based on time information (e.g., Time Window) of the route selection descriptor. Each of values 671a, 671b, and 671c of the time information 670 may be a value corresponding to each traffic descriptor. The electronic device 101 may configure place information 680 of the event table 640, based on place information (e.g., Location Criteria) of the route selection descriptor. Each of values 681a, 681b, and 681c of the place information 680 may be a value corresponding to each traffic descriptor.

According to various embodiments, the electronic device 101 may identify whether to provide a notification to an application (e.g., the application 401), based on the event table 640. For example, if an identified current time and/or current place corresponds to the time information 670 and/or the place information 680 of the event table 640, the electronic device 101 may provide a notification to an application corresponding to the corresponding event ID. The configuration of the event table 640 is merely illustrative, and the electronic device 101 may use the URSP rule 600 to identify whether to provide the notification to the application. If the identified current time and/or current place corresponds to the time information and/or the place information of the route selection descriptor included in the URSP rule 600, the electronic device 101 may provide the notification to the application corresponding to the corresponding event ID.

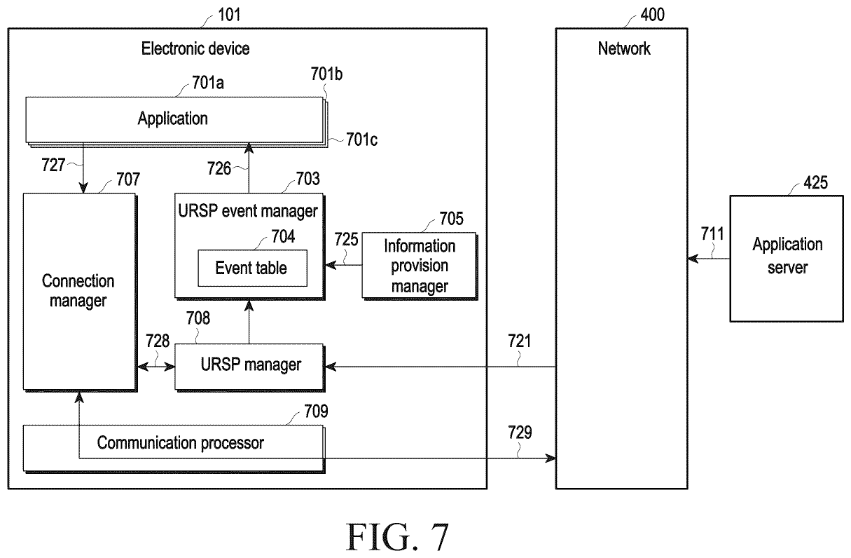

FIG. 7 is a diagram illustrating an entity executing on an electronic device according to various embodiments.

According to various embodiments, in operation 711, the network 400 may obtain information (e.g., URI, time information, and/or place information) for an event from an application server 425. In various embodiments, the network 400 may obtain information (e.g., URI, time information, and/or place information) for an event from an entity other than the application server 425. The network 400 (e.g., a PCF) may configure a URSP rule, based on the obtained information for the event. The electronic device 101 (e.g., the processor 120) may execute a URSP manager 708. In operation 721, the URSP manager 708 may obtain a URSP rule from the network 400 (e.g., a PCF). The URSP manager 708 may store and/or manage the obtained URSP rule. The URSP manager 708 may transmit and/or receive, for example, at least a part of a connection manager 707 and a URSP rule 728, and for example, a mobile data manager (not shown) may transmit and/or receive at least a part of the URSP manager 708 and the URSP rule 728 on behalf of the connection manager 707. A URSP event manager 703 may obtain time information and/or place information 725 from an information provision manager 705. The information provision manager 705 may obtain current time information and/or place information 725 to provide the same to the URSP event manager 703. The URSP event manager 703 may identify an event corresponding to the time information and/or the place information 725 in a stored event table 704 (e.g., the event table 640 of FIG. 6). The URSP event manager 703 may provide a notification 726 to an application 701a corresponding to the identified event. The application 701a may provide a network connection request 727 to the connection manager 707 in response to receiving the notification 726 or in response to a user input identified after the notification 726. The network connection request 727 may include at least a part of a traffic descriptor. The connection manager 707 (or mobile data manager) may request a route selection descriptor from the URSP manager 708, based on at least a part of the traffic descriptor, and in response thereto, the URSP manager 708 may provide a route selection descriptor corresponding to at least a part of the traffic descriptor to the connection manager 707 (or mobile data manager). The connection manager 707 (or mobile data manager) may request a communication processor 709 to establish a PDU session. The communication processor 709 may establish a PDU session 729. For example, applications 701a, 701b, and 701c, the URSP event manager 703, the information provision manager 705, the connection manager 707, and the URSP manager 708 may be executed by an application processor. At least one of the applications 701a, 701b, and 701c, the URSP event manager 703, the information provision manager 705, the connection manager 707, or the URSP manager 708 may be executed by the communication processor 709, and the remainder may be executed by the application processor.

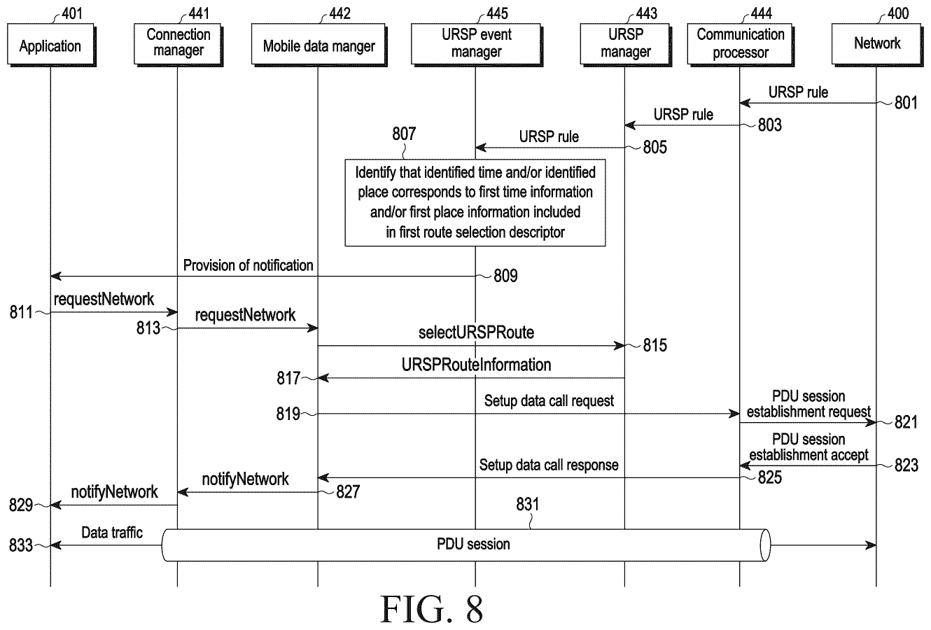

FIG. 8 is a diagram illustrating an operation of an entity executing on an electronic device according to various embodiments.

According to various embodiments, in operation 801, the network 400 may provide a URSP rule to a communication processor 444. In operation 803, the communication processor 444 may provide the URSP rule to a URSP manager 443. The URSP manager 443 may store and/or manage the URSP rule. The URSP manager 443 may later provide a route selection descriptor in response to a request for a route selection descriptor based on a network connection request of a specific application. In operation 805, the URSP manager 443 may provide the URSP rule to a URSP event manager 445. The URSP event manager 445 may configure an event table (e.g., the event table 640) by using the provided URSP rule. This is an example, and the URSP event manager 445 may determine whether to provide a notification by using the URSP rule without configuring the event table. Alternatively, in another example, the URSP manager 443 may determine whether to provide a notification by using the URSP rule, and in this case, the URSP event manager 445 may be executed or may not be defined.

According to various embodiments, in operation 807, the URSP event manager 445 may identify that an identified time and/or an identified place corresponds to first time information and/or first place information included in a first route selection descriptor. Based on the identified time and/or the identified place corresponding to the first time information and/or the first place information included in the first route selection descriptor, the URSP event manager 445 may identify the application 401 by using a first traffic descriptor corresponding to the first route selection descriptor. For example, the URSP event manager 445 may identify the application 401, based on an AppID included in the first traffic descriptor. Alternatively, the URSP event manager 445 may identify the application 401, based on an AppID included in an event ID corresponding to the first route selection descriptor of the event table (e.g., the event table 640). In operation 809, the URSP event manager 445 may provide a notification to the identified application 401. The notification may include, for example, metadata (e.g., at least a part of a traffic descriptor). In operation 811, in response to the notification, the application 401 may provide a network connection request (e.g., requestNetwork) to a connection manager 441. The network connection request may include, for example, metadata. In an example, the application 401 may provide the network connection request, based on additional identification from a user. Alternatively, the application 401 may provide the network connection request in response to receiving the notification. In operation 813, the connection manager 441 may provide the network connection request to a mobile data manager 442. In operation 815, the mobile data manager 442 may provide a route selection descriptor request (e.g., selectURSPRoute) to the URSP manager 443, based on the reception of the network connection request. The route selection descriptor request may include, for example, an AppID and/or metadata, for example, at least a part of a traffic descriptor. The URSP manager 443 may identify a route selection descriptor corresponding to the route selection descriptor request, based on the reception of the route selection descriptor request. For example, the URSP manager 443 may use the URSP rule to identify the route selection descriptor corresponding to the AppID and/or the metadata included in the route selection descriptor request. In operation 817, the URSP manager 443 may provide information (e.g., URSPRouteInformation) associated with the route selection descriptor to the mobile data manager 442. The information associated with the route selection descriptor may include at least a part of the route selection descriptor. In operation 819, the mobile data manager 442 may provide a setup data call request to the communication processor 444. The setup data call request may include at least a part of the route selection descriptor. In operation 821, the communication processor 444 may transmit a PDU session establishment request message to the network 400, based on the reception of the setup data call request. Based on the reception of the PDU session establishment request message, the network 400 may perform at least one operation for establishing a PDU session. The network 400 may perform the at least one operation for establishing the PDU session and, in operation 823, transmit a PDU session establishment accept message to the communication processor 444. In operation 825, the communication processor 444 may provide a setup data call response to the mobile data manager 442. In operation 827, the mobile data manager 442 may provide a network notification (notifyNetwork) to the connection manager 441. In operation 829, the connection manager 441 may provide the network notification (notifyNetwork) to the application 401. The application 401 may transmit and/or receive traffic 833 through a subsequently established PDU session 831. For example, the application 401 may transmit and/or receive the traffic 833, based on a socket corresponding to the PDU session 831, and this may be expressed as transmission and/or reception of the traffic 833 through the PDU session 831. According to the above, if a condition associated with time information and/or place information is satisfied, a corresponding PDU session may be established automatically or based on additional identification by a user.

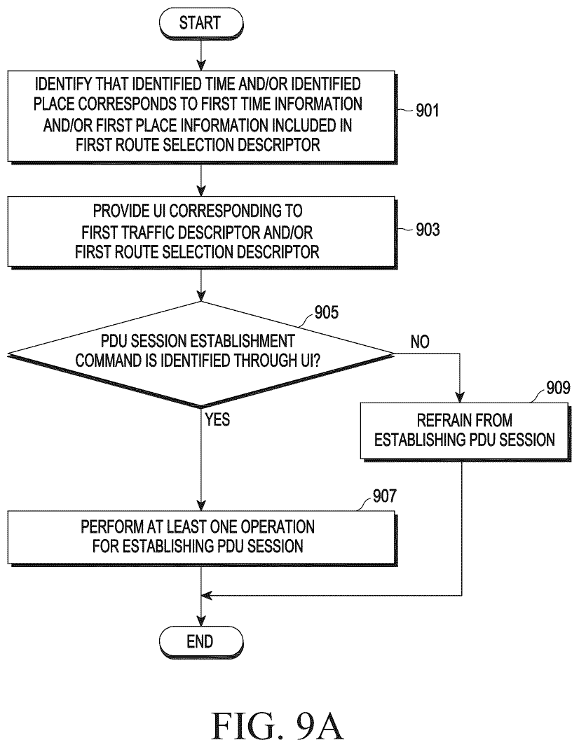

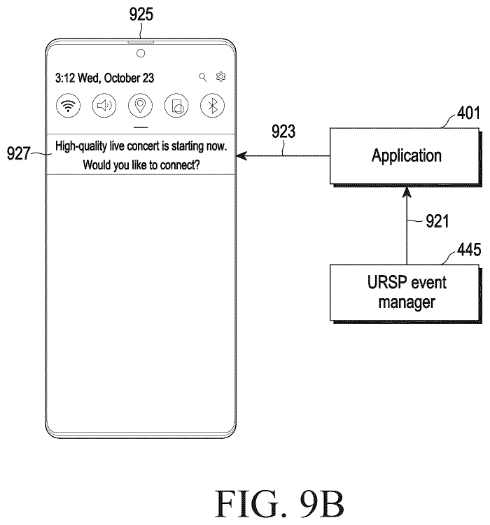

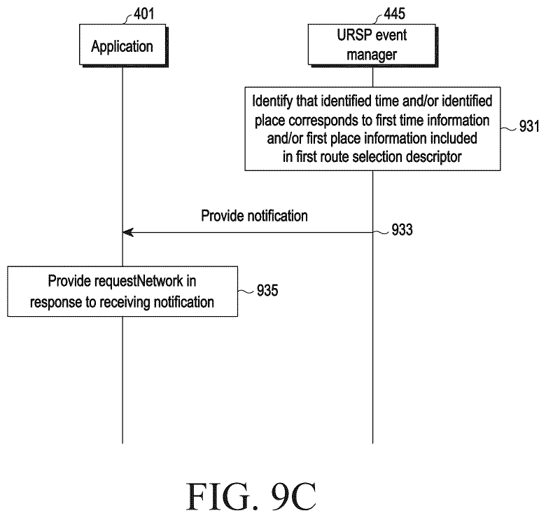

FIG. 9A is a flowchart illustrating an operating method of an electronic device according to various embodiments. The embodiment of FIG. 9A will be described with reference to FIG. 9B. FIG. 9B is a diagram illustrating a UI provided by an electronic device according to various embodiments.

According to various embodiments, in operation 901, the electronic device 101 (e.g., at least a part of the processor 120, the first communication processor 212, the second communication processor 214, or the integrated communication processor 260) may identify that an identified time and/or an identified place corresponds to first time information and/or first place information included in a first route selection descriptor. In operation 903, the electronic device 101 may provide a UI corresponding to a first traffic descriptor and/or the first route selection descriptor. For example, the electronic device 101 may display a UI 925 as shown in FIG. 9B. The UI 925 may include, for example, a notification 927 which inquires about whether a PDU session is established, and the notification 927 may include text that is easy for a user to understand (e.g., “The high-quality live concert is starting now. Would you like to connect?”). For example, the URSP event manager 445 may identify that the identified time and/or the identified place corresponds to the first time information and/or the first place information included in the first route selection descriptor. The URSP event manager 445 may provide a notification 921 to the application 401 corresponding to the first traffic descriptor and/or a first route. The application 401 may provide information 923 for configuring the UI 925 including the notification 927, based on the notification 921. In an example, the application 401 may provide the information 923 to a notification manager (not shown), and the notification manager (not shown) may provide the UI 925 based on the information 923, but is not limited thereto. In another embodiment, the electronic device 101 may receive additional information (e.g., an image file) associated with an event from an application server, and configure the UI 925 by using the additional information together. For example, the application 401 may request the additional information from the application server, based on the reception of the notification. The application 401 may request the additional information from the application server by using meta information (e.g., FQDN) included in the notification. In response to the request, the application server may provide the additional information associated with the event to the electronic device 101 (e.g., the application 401). The electronic device 101 (e.g., the application 401) may configure the UI 925 by using the additional information. Referring again to FIG. 9A, in operation 905, the electronic device 101 may identify whether a PDU session establishment command is identified through the UI. For example, the electronic device 101 may identify whether a PDU session establishment command (or an application execution command) is obtained, based on an input for the notification 927 in FIG. 9B or an additional input after the input for the notification 927. Meanwhile, the UI 925 described with reference to FIG. 9B is a visual UI, however, this is just an example, and the UI 925 may be provided in various manners, such as an auditory manner, as well as the visual manner, and it may be determined whether a user input also is obtained in a corresponding manner according to the various manners. If the PDU session establishment command is obtained (905—Yes), the electronic device 101 may perform at least one operation for establishing a PDU session in operation 907. If the PDU session establishment command is not obtained (905—No), the electronic device 101 may refrain from establishing a new PDU session in operation 909. As described above, the user may identify whether a PDU session can be established, based on the provided UI 925, and input a corresponding PDU session establishment command into the electronic device 101.

FIG. 9C is a flowchart illustrating an operating method of an electronic device according to various embodiments.

According to various embodiments, in operation 931, the URSP event manager 445 may identify that the identified time and/or the identified place corresponds to the first time information and/or the first place information included in the first route selection descriptor. The URSP event manager 445 may identify the application 401 corresponding to the first route selection descriptor and/or the first traffic descriptor. In operation 933, the URSP event manager 445 may provide a notification to the identified application 401. In operation 935, the application 401 may provide a network connection request (e.g., requestNetwork) in response to receiving the notification. A PDU session may be established based on the network connection request. The application 401 may provide the network connection request in response to receiving the notification without requiring any particular identification from a user. Accordingly, for example, the PDU session may be automatically established even when the user does not identify the electronic device 101 at a specific time and/or in a specific place.

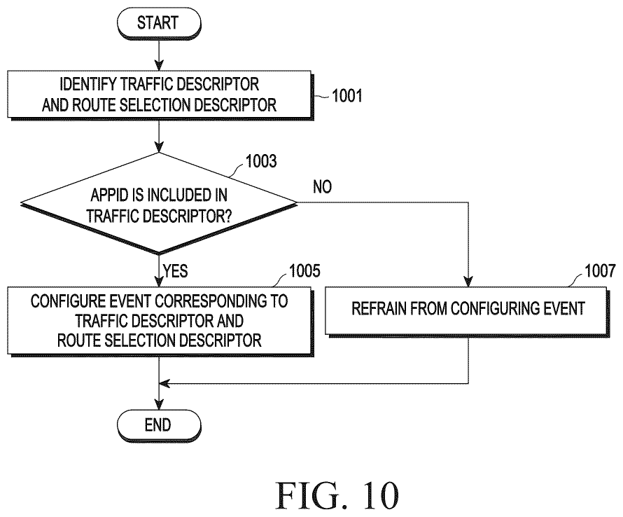

FIG. 10 is a flowchart illustrating an operating method of an electronic device according to various embodiments.

According to various embodiments, in operation 1001, the electronic device 101 (e.g., at least a part of the processor 120, the first communication processor 212, the second communication processor 214, or the integrated communication processor 260) may identify a traffic descriptor and a route selection descriptor included in a URSP rule. For example, the electronic device 101 may obtain the URSP rule from a network (or another entity), and identify the traffic descriptor and the route selection descriptor included in the URSP rule at a time point of the obtaining (or another time point). In operation 1003, the electronic device 101 may identify whether an AppID is included in the traffic descriptor. For example, the electronic device 101 may obtain the URSP rule as shown in Table 2. It should be appreciated that the rules shown in Table 2 are merely examples and that other rules are possible in other embodiments.

TABLE 2

| Rule | Rule | Traffic | |
|---|---|---|---|
| number | precedence | description | Route selection descriptor |
| 1 | 1 | App Descriptor = | Precedence = 1 |
| | | AppID2FQDN = | S-NSSAI = 105, DNN = |
| | | FQDN_1 | internet.mno4.com |
| | | | Time Window = TimeVal_d1~ |
| | | | TimeVal_d2 |
| | | | Location Criteria = Location_d |
| 2 | 2 | * | Precedence = 1 |
| | | | S-NSSAI = 1, DNN = |
| | | | internet.mno2.com |

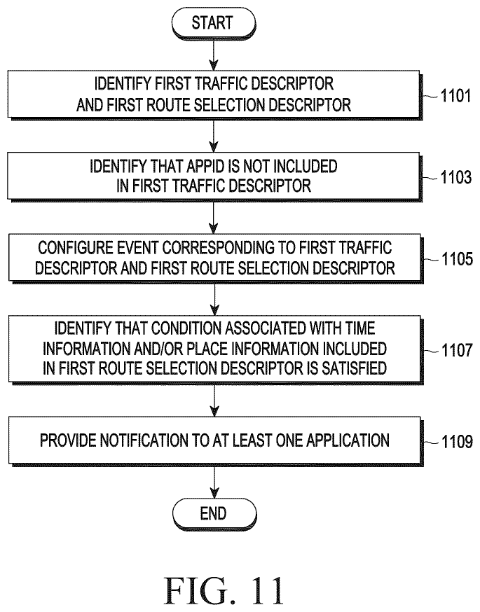

The electronic device 101 may identify that “AppID2” is included in the traffic descriptor with respect to rule number “1”. The electronic device 101 may identify that “AppID2” is not included in the traffic descriptor with respect to rule number “2”. If the AppID is included in the traffic descriptor (1003—Yes), the electronic device 101 may configure an event corresponding to the traffic descriptor and the route selection descriptor in operation 1005. If the AppID is not included in the traffic descriptor (1003—No), the electronic device 101 may refrain from configuring an event corresponding to the traffic descriptor and the route selection descriptor in operation 1007. For example, the electronic device 101 may configure an event with respect to rule number “1”. Accordingly, the electronic device 101 may provide a notification to an application corresponding to the AppID2 when an identified time satisfies a condition of TimeVal_d1˜Time Val_d2 and an identified place satisfies “Location_d”. If a network connection request is identified from the application corresponding to the AppID2, the electronic device 101 may perform at least one operation for establishing a PDU session based on the route selection descriptor of rule number “1”. The electronic device 101 may not configure an event with respect to rule number “2”. For example, since an application required to provide a notification when an event is satisfied is not defined, the electronic device 101 may not configure the event with respect to rule number “2”. For example, when the URSP rule includes a plurality of rules, the electronic device 101 may configure an event with respect to some rules and may not configure an event with respect to the remaining rules. FIG. 11 is a flowchart illustrating an operating method of an electronic device according to various embodiments.

According to various embodiments, in operation 1101, the electronic device 101 (e.g., at least a part of the processor 120, the first communication processor 212, the second communication processor 214, or the integrated communication processor 260) may identify a first traffic descriptor and a first route selection descriptor. In operation 1103, the electronic device 101 may identify that an AppID is not included in the first traffic descriptor. For example, the electronic device 101 may identify a traffic descriptor of “DNN=internet”, and a corresponding route selection descriptor of “Precedence=1, S-NSSAI=102, SSC Mode=2, Time Window=Time Val_a1˜Time Val_a2, and Location Criteria =Location_a”. Even when the AppID is not included in the traffic descriptor, the electronic device 101 may configure an event corresponding to the first traffic descriptor and the first route selection descriptor in operation 1105. In operation 1107, the electronic device 101 may identify that a condition associated with time information and/or place information included in the first route selection descriptor is satisfied. For example, the electronic device 101 may identify that an identified time is included in TimeVal_a1˜Time Val_a2 and/or an identified place is Location_a. In operation 1109, the electronic device 101 may provide a notification to at least one application. In an example, the electronic device 101 may provide a notification with respect to all installed applications or all running applications. In another example, the electronic device 101 may provide a notification to at least one pre-designated application. There is no limitation on an application that provides a notification.

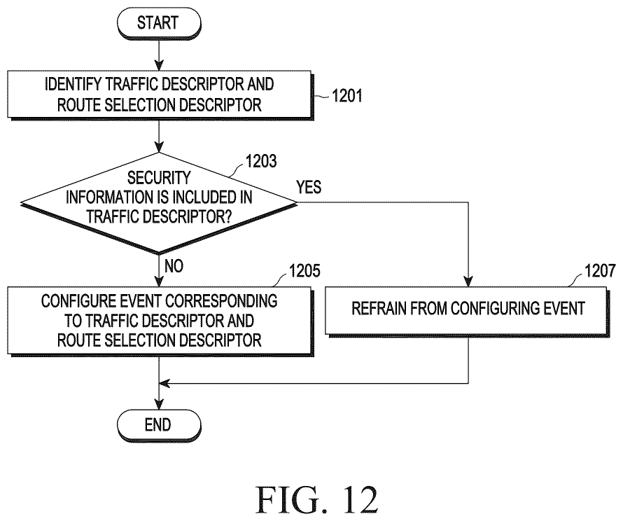

FIG. 12 is a flowchart illustrating an operating method of an electronic device according to various embodiments.

According to various embodiments, in operation 1201, the electronic device 101 (e.g., at least a part of the processor 120, the first communication processor 212, the second communication processor 214, or the integrated communication processor 260) may identify a traffic descriptor and a route selection descriptor. In operation 1203, the electronic device 101 may identify whether security information is included in the traffic descriptor. For example, the security information may be an IP address, but there is no limitation on the type thereof. For example, the electronic device 101 may obtain a URSP rule as shown in Table 3. It should be appreciated that the rules shown in Table 3 are merely examples and that other rules are possible in other embodiments.

TABLE 3

| Rule | Rule | Traffic | |
|---|---|---|---|
| number | precedence | descriptor | Route selection descriptor |
| 1 | 1 | App | Precedence = 1 |
| | | Descriptor = | S-NSSAI = 102, SSC Mode = 2 |
| | | AppID2FQDN = | Time Window = TimeVal_a1~ |
| | | FQDN_1 | Time Val_a2 |
| | | | Location Criteria = Location_a |
| 2 | 2 | App | Precedence = 1 |
| | | Descriptor = | S-NSSAI = 104, DNN = |
| | | AppID3 IP = | internet.mno3.com |
| | | 10.10.10.1, | SSC Mode = 1 |
| | | port = 10040, | Time Window = TimeVal_c1~ |
| | | protocol = TCP | Time Val_c2 |
| | | | Location Criteria = Location_c |

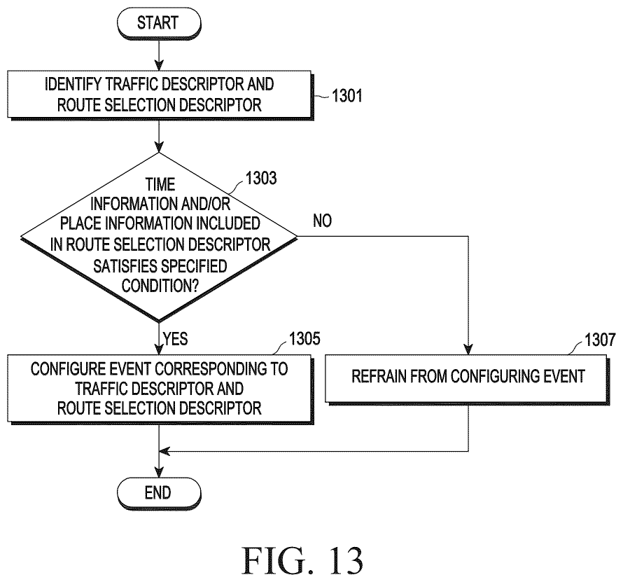

The electronic device 101 may identify that security information (e.g., an IP address) is not included in the traffic descriptor with respect to rule number “1”. The electronic device 101 may identify that the security information (e.g., an IP address) is included in the traffic descriptor with respect to rule number “2”. If the security information is not included in the traffic descriptor (1203—No), the electronic device 101 may configure an event corresponding to the traffic descriptor and the route selection descriptor in operation 1205. If the security information is included in the traffic descriptor (1203—Yes), the electronic device 101 may refrain from configuring an event corresponding to the traffic descriptor and the route selection descriptor in operation 1207. For example, the electronic device 101 may configure an event with respect to rule number “1”. Accordingly, the electronic device 101 may provide a notification to an application corresponding to AppID2 when an identified time satisfies a condition of TimeVal_d1˜TimeVal_d2 and an identified place satisfies “Location_d”. If a network connection request is identified from the application corresponding to the AppID2, the electronic device 101 may perform at least one operation for establishing a PDU session based on the route selection descriptor of rule number “1”. The electronic device 101 may not configure an event with respect to rule number “2”. For example, when the URSP rule includes a plurality of rules, the electronic device 101 may configure an event with respect to some rules and may not configure an event with respect to the remaining rules. FIG. 13 is a flowchart illustrating an operating method of an electronic device according to various embodiments.

According to various embodiments, in operation 1301, the electronic device 101 (e.g., at least a part of the processor 120, the first communication processor 212, the second communication processor 214, or the integrated communication processor 260) may identify a traffic descriptor and a route selection descriptor. In operation 1303, the electronic device 101 may identify whether time information and/or place information included in the route selection descriptor satisfies a specified condition. For example, the specified condition may include that the time information included in the route selection descriptor is not “every time” and/or the place information is not “everywhere”. The time information being “every time” may mean that a corresponding rule is valid at every time, and the place information being “everywhere” may mean that a corresponding rule is valid everywhere. For example, the electronic device 101 may obtain a URSP rule as shown in Table 4. It should be appreciated that the rules shown in Table 4 are merely examples and that other rules are possible in other embodiments.

TABLE 4

| Rule | Rule | Traffic | |
|---|---|---|---|
| number | precedence | descriptor | Route selection descriptor |
| 1 | 1 | App Descriptor = | [RSD1] |
| | | AppID1FQDN = | Precedence = 1 |
| | | FQDN_1 | S-NSSAI = 102, |
| | | | SSC Mode = 2 |
| | | | Time Window = |
| | | | TimeVal_a1~TimeVal_a2 |
| | | | Location Criteria = Location_a |
| 2 | 2 | App Descriptor = | [RSD2] |
| | | AppID2FQDN = | Precedence = 2 |
| | | FQDN_1 | Time Window = every time, |
| | | | Location Criteria = every where |

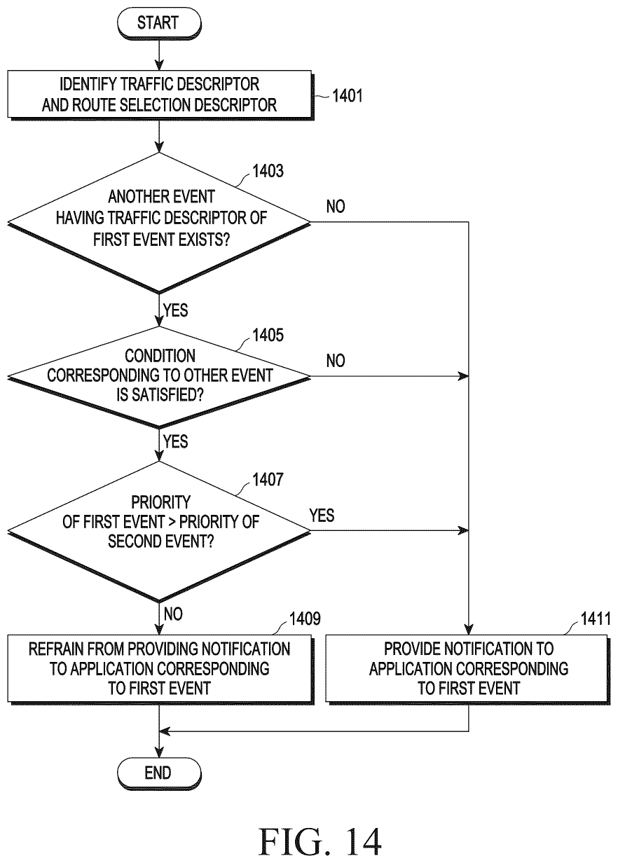

With respect to rule number “1”, the electronic device 101 may identify that the time information and/or the place information satisfies the specified condition, for example, the time information is not “every time” and/or the place information is not “everywhere”. With respect to rule number “2”, the electronic device 101 may identify that the time information and/or the place information does not satisfy the specified condition, for example, the time information is “every time” and/or the place information is “everywhere”. If the time information and/or the place information satisfies the specified condition (1303—Yes), the electronic device 101 may configure an event corresponding to the traffic descriptor and the route selection descriptor in operation 1305. If the time information and/or the place information does not satisfy the specified condition (1303—No), the electronic device 101 may refrain from configuring an event corresponding to the traffic descriptor and the route selection descriptor in operation 1307. For example, the electronic device 101 may configure an event with respect to rule number “1”. Accordingly, the electronic device 101 may provide a notification to an application corresponding to AppID2 when an identified time satisfies a condition of TimeVal_d1˜TimeVal_d2 and an identified place satisfies “Location_d”. If a network connection request is identified from the application corresponding to the AppID2, the electronic device 101 may perform at least one operation for establishing a PDU session based on the route selection descriptor of rule number “1”. The electronic device 101 may not configure an event with respect to rule number “2”. For example, when the URSP rule includes a plurality of rules, the electronic device 101 may configure an event with respect to some rules and may not configure an event with respect to the remaining rules. FIG. 14 is a flowchart illustrating an operating method of an electronic device according to various embodiments.

According to various embodiments, in operation 1401, the electronic device 101 (e.g., at least a part of the processor 120, the first communication processor 212, the second communication processor 214, or the integrated communication processor 260) may identify that a condition corresponding to a first event is satisfied. In operation 1403, the electronic device 101 may identify whether another event having a traffic descriptor of the first event exists. For example, in the electronic device 101, for one traffic descriptor, one route selection descriptor may be configured or a plurality of route selection descriptors may be configured. If the plurality of route selection descriptors are configured for one traffic descriptor, the electronic device 101 may configure another event having the traffic descriptor of the first event. If the other event having the traffic descriptor of the first event exists (1403—Yes), the electronic device 101 may identify whether a condition corresponding to the other event is satisfied, in operation 1405. If a condition corresponding to a second event, which is another event, is satisfied (1405—Yes), the electronic device 101 may identify whether a priority of the first event is higher than a priority of the second event, in operation 1407. If the priority of the first event is lower than or equal to the priority of the second event (1407—No), the electronic device 101 may refrain from providing a notification to an application corresponding to the first event in operation 1409. Accordingly, a PDU session corresponding to the second event may be established with priority over a PDU session corresponding to the first event. If the priority of the first event is higher than the priority of the second event (1407—Yes), the electronic device 101 may provide the notification to the application corresponding to the first event in operation 1411. Even if the other event having the traffic descriptor of the first event does not exist (1403—No) or the condition corresponding to the other event is not satisfied (1405—No), the electronic device 101 may provide the notification to the application corresponding to the first event in operation 1411. Accordingly, if conditions associated with time information and/or place information of a plurality of route selection descriptors for one traffic descriptor are satisfied at least simultaneously, the electronic device 101 may provide, to an application, a notification corresponding to an event having a relatively high priority.

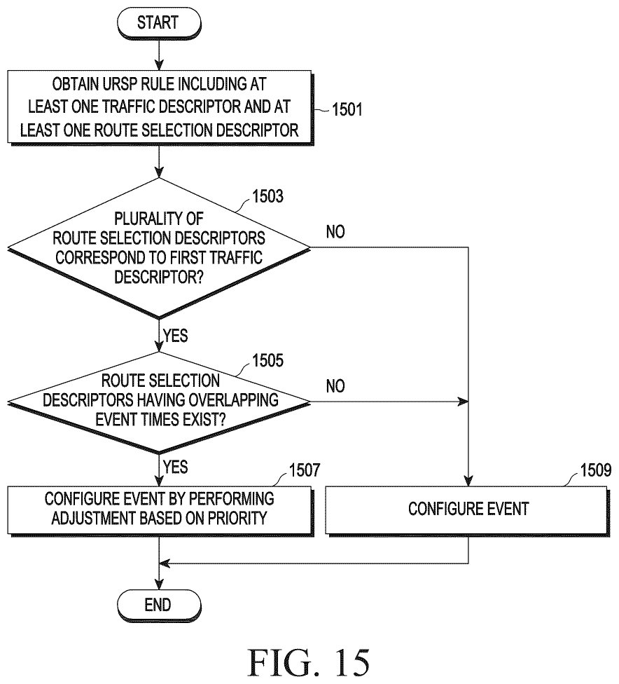

FIG. 15 is a flowchart illustrating an operating method of an electronic device according to various embodiments.

According to various embodiments, in operation 1501, the electronic device 101 (e.g., at least a part of the processor 120, the first communication processor 212, the second communication processor 214, or the integrated communication processor 260) may obtain a URSP rule including at least one traffic descriptor and at least one route selection descriptor. In operation 1503, the electronic device 101 may identify whether a plurality of route selection descriptors correspond to a first traffic descriptor. If the plurality of route selection descriptors correspond to the first traffic descriptor (1503—Yes), the electronic device 101 may identify whether route selection descriptors having overlapping event times exist, in operation 1505. If the route selection descriptors having overlapping event times exist (1505—Yes), the electronic device 101 may configure an event by performing adjustment based on a priority in operation 1507. For example, the electronic device 101 may obtain a URSP rule in which the plurality of route selection descriptors correspond to one traffic descriptor, as shown in Table 5. It should be appreciated that the information shown in Table 5 is merely an example and that other information is possible in other embodiments.

TABLE 5

| Rule | Rule | Traffic | |
|---|---|---|---|
| number | procedure | descriptor | Route selection descriptor |
| 1 | 1 | App | [RSD(route selection descriptor) I] |
| | | Descriptor = | Precedence = 1 |
| | | AppID1 | S-NSSAI = 102, SSC Mode = 2 |
| | | | Time Window = TimeVal_a1~ |
| | | | TimeVal_a3 |
| | | | Location Criteria = Location_a |
| | | | [RSD 2] |
| | | | Precedence = 2 |
| | | | S-NSSAI = 103, DNN = |
| | | | internet.mno.com |
| | | | SSC Mode = 1 |
| | | | Time Window = TimeVal_a2~ |
| | | | TimeVal_a4 |
| | | | Location Criteria = Location_b |

Referring to Table 5, time information (Time window) included in a first route selection descriptor may have a value of a1 to a3, and time information (Time window) included in a second route selection descriptor may have a value of a2 to a4. For example, a1, a2, a3, and a4 may each mean a time point, and are assumed to have the time order of a1, a2, a3, and a4. The electronic device 101 may identify that event times of the first route selection descriptor and the second route selection descriptor overlap at a period from time point a2 to time point a3. In this case, the electronic device 101 may configure an event by using the first route selection descriptor having a higher priority during the corresponding time. Accordingly, the electronic device 101 may configure an event table as shown in Table 6. It should be appreciated that the events shown in Table 6 are merely examples and that other events are possible in other embodiments.

TABLE 6

| Event ID | Time Window | Location Criteria |
|---|---|---|
| AppID1 | a1 to a3 | Location_a |
| | a3 to a4 | Location_b |

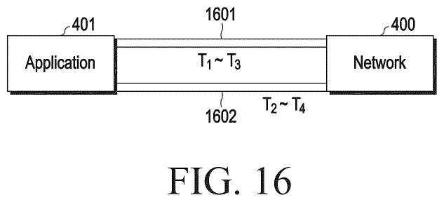

As shown in Table 6, with respect to overlapping time points a2 to a3, the electronic device 101 may configure, as an event, place information (e.g., Location_a) included in a route selection descriptor having a higher priority. If the plurality of route selection descriptors do not correspond to the first traffic descriptor (1503—No), or if the route selection descriptors having overlapping event times do not exist (1505—No), the electronic device 101 may configure an event, based on at least one traffic descriptor and at least one route selection descriptor, in operation 1509. FIG. 16 is a flowchart illustrating a PDU session established by an electronic device according to various embodiments.

According to various embodiments, the electronic device 101 (e.g., at least a part of the processor 120, the first communication processor 212, the second communication processor 214, or the integrated communication processor 260) may obtain, for example, a URSP rule as shown in Table 4. As described with reference to Table 4, at a period from time point a2 to time point a3, event times of a first route selection descriptor and a second route selection descriptor may overlap. The electronic device 101 may provide a notification to the application 401 at a period from time point a1 to time point a3. If a network connection request is identified from the application 401, the electronic device 101 may establish a first PDU session 1601. At a period from time point a2 to time point a4, the electronic device 101 may provide a notification to the application 401. If a network connection request is identified from the application 401, the electronic device 101 may establish a second PDU session 1602. For example, the first PDU session 1601 and the second PDU session 1602 may be established at least simultaneously.

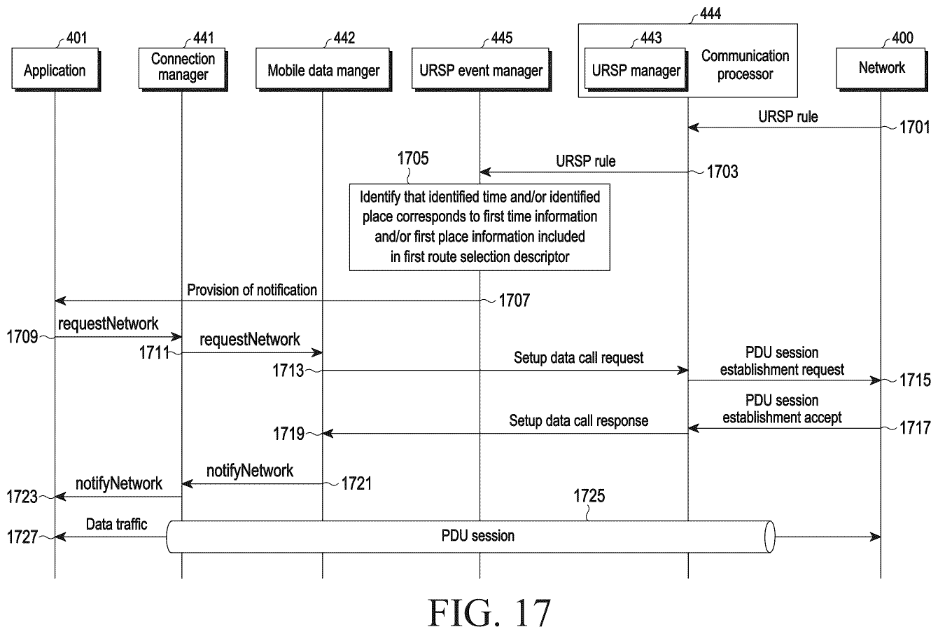

FIG. 17 is a diagram illustrating an operation of an entity executing on an electronic device according to various embodiments.

According to various embodiments, in operation 1701, the network 400 may provide a URSP rule to the communication processor 444. In the embodiment of FIG. 17, the URSP manager 443 may be included (or executed) in the communication processor 444. Accordingly, the URSP manager 443 may store and/or manage the URSP rule. In operation 1703, the communication processor 444 (or the URSP manager 443) may provide the URSP rule to the URSP event manager 445. The URSP event manager 445 may configure an event table (e.g., the event table 640) by using the provided URSP rule.

According to various embodiments, in operation 1705, the URSP event manager 445 may identify that an identified time and/or an identified place corresponds to first time information and/or first place information included in a first route selection descriptor. Based on the identified time and/or the identified place corresponding to the first time information and/or the first place information included in the first route selection descriptor, the URSP event manager 445 may identify the application 401 by using a first traffic descriptor corresponding to the first route selection descriptor. In operation 1707, the URSP event manager 445 may provide a notification to the identified application 401. The notification may include, for example, metadata (e.g., at least a part of a traffic descriptor). In operation 1709, in response to the notification, the application 401 may provide a network connection request (e.g., requestNetwork) to the connection manager 441. The network connection request may include, for example, metadata. In operation 1711, the connection manager 441 may provide the network connection request to the mobile data manager 442. In operation 1713, the mobile data manager 442 may provide a setup data call request to the communication processor 444, based on the reception of the network connection request. The setup data call request may include at least a part of a route selection descriptor. The communication processor 444 may identify a corresponding route selection descriptor, based on the setup data call request. In operation 1715, the communication processor 444 may transmit a PDU session establishment request message to the network 400, based on the reception of the setup data call request. Based on the reception of the PDU session establishment request message, the network 400 may perform at least one operation for establishing a PDU session. The network 400 may perform the at least one operation for establishing the PDU session and, in operation 1717, transmit a PDU session establishment accept message to the communication processor 444. In operation 1719, the communication processor 444 may provide a setup data call response to the mobile data manager 442. In operation 1721, the mobile data manager 442 may provide a network notification (notifyNetwork) to the connection manager 441. In operation 1723, the connection manager 441 may provide the network notification (notifyNetwork) to the application 401. The application 401 may transmit and/or receive traffic 1727 through a subsequently established PDU session 1725.

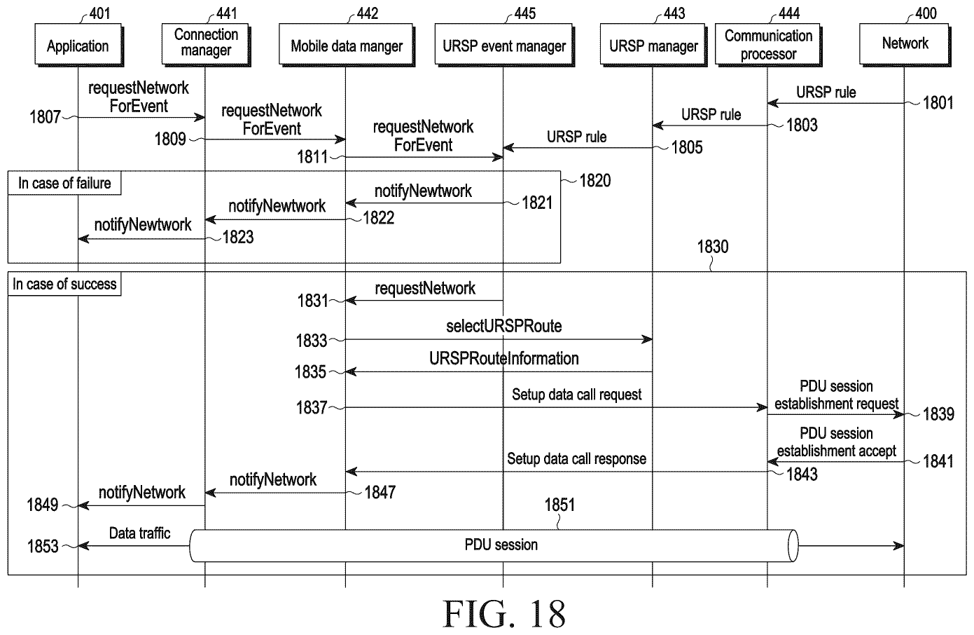

FIG. 18 is a diagram illustrating an operation of an entity executing on an electronic device according to various embodiments.

According to various embodiments, in operation 1801, the network 400 may provide a URSP rule to the communication processor 444. In operation 1803, the communication processor 444 may provide the URSP rule to the URSP manager 443. The URSP manager 443 may store and/or manage the URSP rule. In operation 1805, the URSP manager 443 may provide the URSP rule to the URSP event manager 445. The URSP event manager 445 may configure an event table (e.g., the event table 640) by using the provided URSP rule.

According to various embodiments, in operation 1807, the application 401 may provide a network connection request (requestNetworkForEvent) for an event to the connection manager 441. For example, when the electronic device 101 satisfies an event without receiving a notification internally, the application 401 may provide, to the connection manager 441, the network connection request (requestNetworkForEvent) for an event for requesting a PDU session. For example, when a connection request for an event is received from a connecting server, the application 401 may provide the network connection request (requestNetworkForEvent) for the event to the connection manager 441. In an example, the application 401 may receive time information (e.g., 2:00 pm) of the event from the connecting server. The application 401 may provide the network connection request (requestNetworkForEvent) for the event to the connection manager 441 at a time point specified in the corresponding time information or an earlier time point. In this case, the network connection request (requestNetworkForEvent) for the event may include the time information (e.g., 2:00 pm). For example, the application 401 may provide the network connection request (requestNetworkForEvent) for the event to the connection manager 441, based on an external input (e.g., a user input). For example, when at least one of sensing information, GPS information, or time information satisfies a specified condition, the application 401 may provide the network connection request (requestNetworkForEvent) for the event to the connection manager 441, and there is no limitation on a specified condition and a parameter for determination. In operation 1809, the connection manager 441 may provide the network connection request (requestNetworkForEvent) for the event to the mobile data manager 442. In operation 1811, the mobile data manager 442 may provide the network connection request (requestNetworkForEvent) for the event to the URSP event manager 445.

According to various embodiments, the URSP event manager 445 may monitor whether a condition for the event is satisfied, based on the reception of the network connection request (requestNetworkForEvent) for the event. The URSP event manager 445 may identify an event to be monitored, based on information (e.g., metadata) included in the network connection request (requestNetworkForEvent) for the event. If the condition for the event is not satisfied (1820), the URSP event manager 445 may provide NotifyNetwork including information of “fail” to the mobile data manager 442 in operation 1821. For example, if the identification of the corresponding event fails, the URSP event manager 445 may provide NotifyNetwork including the information of “fail”. In operation 1823, the mobile data manager 442 may provide NotifyNetwork including the information of “fail” to the connection manager 441. In operation 1825, the connection manager 441 may provide NotifyNetwork including the information of “fail” to the application 401.

If the condition for the event is satisfied (1830), the URSP event manager 445 may provide a network connection request (requestNetwork) to the mobile data manager 442. For example, if the corresponding event exists, the URSP event manager 445 may monitor whether the condition is satisfied, and may provide the network connection request (requestNetwork) when the condition for the event is satisfied. The network connection request (requestNetwork) may include, for example, an AppID and/or metadata. In operation 1833, the mobile data manager 442 may provide a route selection descriptor request (e.g., selectURSPRoute) to the URSP manager 443, based on the reception of the network connection request. The route selection descriptor request may include, for example, an AppID and/or metadata, for example, at least a part of a traffic descriptor. The URSP manager 443 may identify a route selection descriptor corresponding to the route selection descriptor request, based on the reception of the route selection descriptor request. For example, the URSP manager 443 may use the URSP rule to identify the route selection descriptor corresponding to the AppID and/or the metadata included in the route selection descriptor request. In operation 1835, the URSP manager 443 may provide information (e.g., URSPRouteInformation) associated with the route selection descriptor to the mobile data manager 442. The information associated with the route selection descriptor may include at least a part of the route selection descriptor. In operation 1837, the mobile data manager 442 may provide a setup data call request to the communication processor 444. The setup data call request may include at least a part of the route selection descriptor. In operation 1839, the communication processor 444 may transmit a PDU session establishment request message to the network 400, based on the reception of the setup data call request. Based on the reception of the PDU session establishment request message, the network 400 may perform at least one operation for establishing a PDU session. The network 400 may perform the at least one operation for establishing the PDU session and, in operation 1841, transmit a PDU session establishment accept message to the communication processor 444. In operation 1843, the communication processor 444 may provide a setup data call response to the mobile data manager 442. In operation 1847, the mobile data manager 442 may provide a network notification (notifyNetwork) including information of “success” to the connection manager 441. In operation 1849, the connection manager 441 may provide the network notification (notifyNetwork) including the information of “success” to the application 401. The application 401 may provide, based on the establishment of the PDU session, a UI indicating the same. For example, the UI may include text indicating the establishment of the PDU session, such as “The high-quality connection has been established.” but there is no limitation on the implementation thereof. The application 401 may transmit and/or receive traffic 1853 through a subsequently established PDU session 1851. For example, the application 401 may transmit and/or receive the traffic 1853, based on a socket corresponding to the PDU session 1851, and this may be expressed as transmission and/or reception of the traffic 1853 through the PDU session 1851. According to the above, if a condition associated with time information and/or place information is satisfied, a corresponding PDU session may be established automatically or based on additional identification by a user.

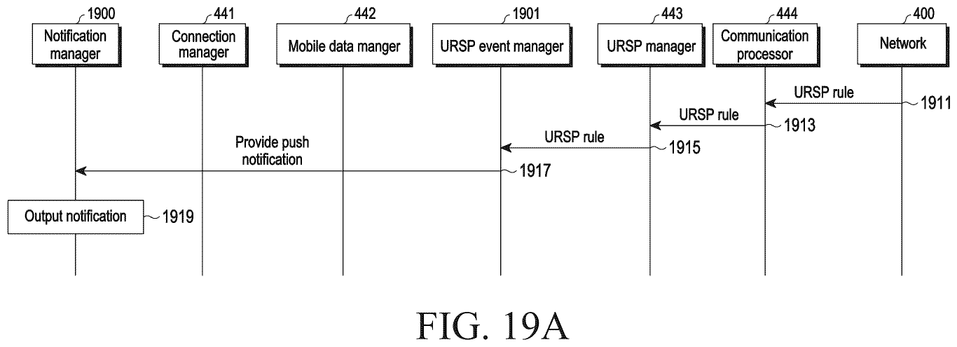

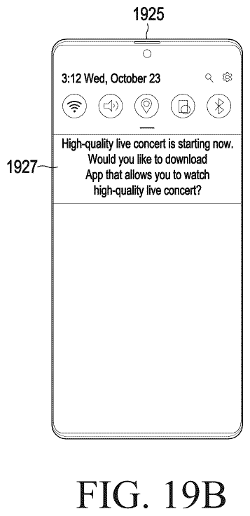

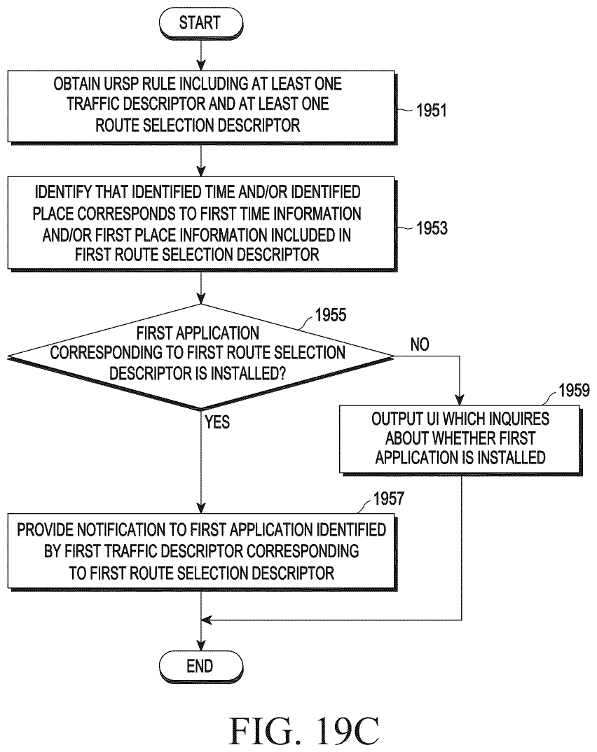

FIG. 19A is a diagram illustrating an operation of an entity executing on an electronic device according to various embodiments. The embodiment of FIG. 19A will be described with reference to FIG. 19B. FIG. 19B is a diagram illustrating a notification according to various embodiments.

According to various embodiments, in operation 1911, the network 400 may provide a URSP rule to the communication processor 444. In operation 1913, the communication processor 444 may provide the URSP rule to the URSP manager 443. The URSP manager 443 may store and/or manage the URSP rule. In operation 1915, the URSP manager 443 may provide the URSP rule to the URSP event manager 445. The URSP event manager 445 may configure an event table (e.g., the event table 640) by using the provided URSP rule. In operation 1917, the URSP event manager 445 may provide a push notification to a notification manager 1900. The push notification may include URL information for installing an application. For example, when it is identified that an identified time and/or an identified place corresponds to first time information and/or first place information included in a first route selection descriptor, the URSP event manager 445 may provide the push notification to the notification manager 1900. Alternatively, for example, when the identified time has a difference of less than a threshold from the first time information included in the first route selection descriptor, the URSP event manager 445 may provide the push notification to the notification manager 1900. In operation 1919, the notification manager 1900 may output a notification, based on the push notification. For example, referring to FIG. 19B, the electronic device 101 may output a UI 1925. The UI 1925 may include, for example, a notification 1927 which inquires about whether to download an application, and the notification 1927 may include text that is easy for a user to understand (e.g., “The high-quality live concert is starting now. Would you like to download an App that allows you to watch the high-quality live concert?”). The electronic device 101 may identify whether a PDU session establishment command (or an application download command) is obtained, based on an input for the notification 1927 in FIG. 19B or an additional input after the input for the notification 1927. The UI 1925 described with reference to FIG. 19B is a visual UI. However, this is just an example, and the UI 1925 may be provided in various manners, such as an auditory manner, as well as the visual manner, and it may be determined whether a user input also is obtained in a corresponding manner according to the various manners. If an application download command is obtained, the electronic device 101 may perform at least one operation for downloading an application by using URL. After the application is downloaded, the URSP event manager 445 may provide a notification to the downloaded application, based on the identified time and/or the identified place corresponding to the first time information and/or the first place information included in the first route selection descriptor. Since a process for establishing a subsequent PDU session has been described with reference to FIG. 8, the description here will be omitted.

FIG. 19C is a diagram illustrating an operating method of an electronic device according to various embodiments.

According to various embodiments, in operation 1951, the electronic device 101 (e.g., at least a part of the processor 120, the first communication processor 212, the second communication processor 214, or the integrated communication processor 260) may obtain a URSP rule including at least one traffic descriptor and at least one route selection descriptor. In operation 1953, the electronic device 101 may identify that an identified time and/or an identified place corresponds to first time information and/or first place information included in a first route selection descriptor. In operation 1955, the electronic device 101 may identify whether a first application corresponding to the first route selection descriptor is installed. If it is identified that the first application is installed (1955—Yes), the electronic device 101 may provide a notification to the first application identified by a first traffic descriptor corresponding to the first route selection descriptor in operation 1957. Thereafter, if a network connection request is identified from the first application, the electronic device 101 may perform at least one operation for establishing a PDU session. If it is not identified that the first application is installed (1955—No), in operation 1959, the electronic device 101 may output a UI which inquires about whether the first application is installed. If an application download command is identified through the UI, the electronic device 101 may perform at least one operation for downloading and/or installing an application. The electronic device 101 may provide a notification through the installed application. Thereafter, if the network connection request is identified from the first application, the electronic device 101 may perform the at least one operation for establishing the PDU session.

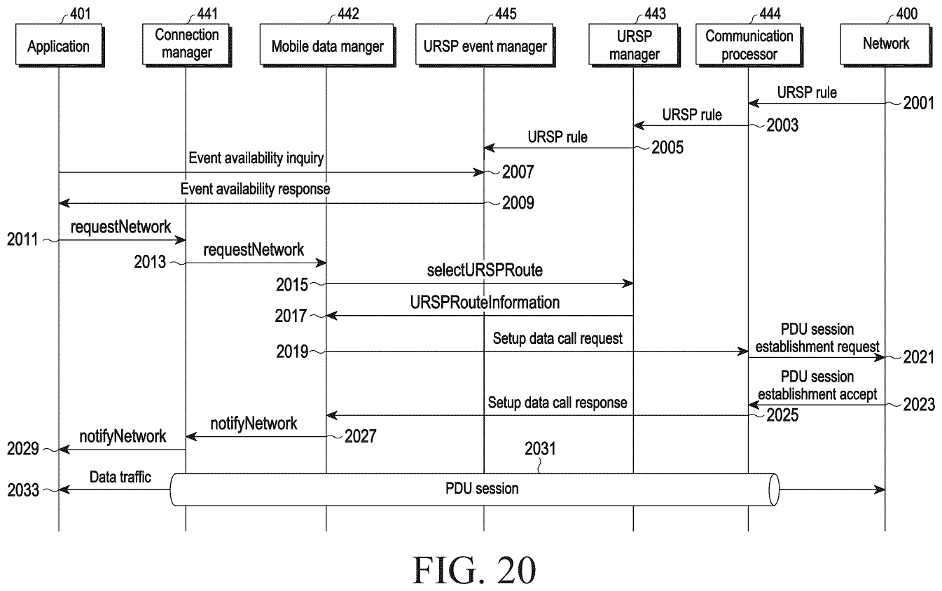

FIG. 20 is a diagram illustrating an operation of an entity executing on an electronic device according to various embodiments.

According to various embodiments, in operation 2001, the network 400 may provide a URSP rule to the communication processor 444. In operation 2003, the communication processor 444 may provide the URSP rule to the URSP manager 443. The URSP manager 443 may store and/or manage the URSP rule. In operation 2005, the URSP manager 443 may provide the URSP rule to the URSP event manager 445. The URSP event manager 445 may configure an event table (e.g., the event table 640) by using the provided URSP rule.

According to various embodiments, in operation 2007, the application 401 may provide an event network slice availability inquiry (requestEventNSAvailability) to the URSP event manager 445. The URSP event manager 445 may identify whether an identified time and/or an identified place corresponds to time information and/or place information of an event corresponding to the application 401. If the identified time and/or the identified place corresponds to the time information and/or the place information of the event corresponding to the application 401, in operation 2009, the URSP event manager 445 may provide a response including information of “available” to the application 401. If the identified time and/or the identified location does not correspond to the time information and/or the place information of the event corresponding to the application 401, in operation 2009, the URSP event manager 445 may provide a response including information of “not” to the application 401. If the response including the information of “available” is provided, the application 401 may provide a network connection request (e.g., requestNetwork) to the connection manager 441 in operation 2011. The network connection request may include, for example, metadata. In operation 2013, the connection manager 441 may provide the network connection request to the mobile data manager 442. In operation 2015, the mobile data manager 442 may provide a route selection descriptor request (e.g., selectURSPRoute) to the URSP manager 443, based on the reception of the network connection request. The route selection descriptor request may include, for example, an AppID and/or metadata, for example, at least a part of a traffic descriptor. The URSP manager 443 may identify a route selection descriptor corresponding to the route selection descriptor request, based on the reception of the route selection descriptor request. For example, the URSP manager 443 may use the URSP rule to identify the route selection descriptor corresponding to the AppID and/or the metadata included in the route selection descriptor request. In operation 2017, the URSP manager 443 may provide information (e.g., URSPRouteInformation) associated with the route selection descriptor to the mobile data manager 442. The information associated with the route selection descriptor may include at least a part of the route selection descriptor. In operation 2019, the mobile data manager 442 may provide a setup data call request to the communication processor 444. The setup data call request may include at least a part of the route selection descriptor. In operation 2021, the communication processor 444 may transmit a PDU session establishment request message to the network 400, based on the reception of the setup data call request. Based on the reception of the PDU session establishment request message, the network 400 may perform at least one operation for establishing a PDU session. The network 400 may perform the at least one operation for establishing the PDU session and, in operation 2023, transmit a PDU session establishment accept message to the communication processor 444. In operation 2025, the communication processor 444 may provide a setup data call response to the mobile data manager 442. In operation 2027, the mobile data manager 442 may provide a network notification (notifyNetwork) to the connection manager 441. In operation 2029, the connection manager 441 may provide the network notification (notifyNetwork) to the application 401. The application 401 may transmit and/or receive traffic 2033 through a subsequently established PDU session 2031.

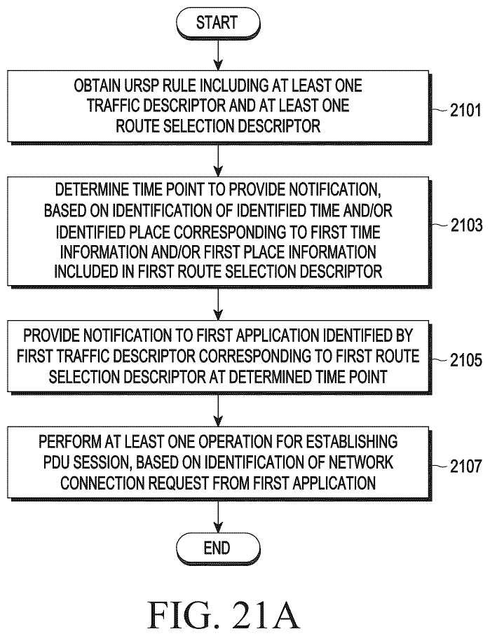

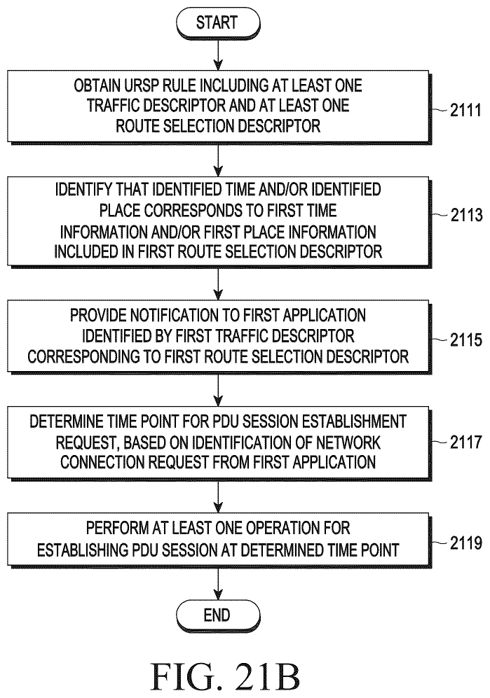

FIG. 21A is a flowchart illustrating an operating method of an electronic device according to various embodiments.

According to various embodiments, in operation 2101, the electronic device 101 (e.g., at least a part of the processor 120, the first communication processor 212, the second communication processor 214, or the integrated communication processor 260) may obtain a URSP rule including at least one traffic descriptor and at least one route selection descriptor. In operation 2103, the electronic device 101 may determine a time point to provide a notification, based on identification of an identified time and/or an identified place corresponding to first time information and/or first place information included in a first route selection descriptor. For example, the electronic device 101 may determine the time point to provide the notification, based on an output value of a random function. For example, the electronic device 101 may determine the time point to provide the notification, based on a result of processing (e.g., hashing) at least one of IMEI, IMSI, a Phone Number, a MAC address, an IP address, or time information, and there is no limitation on a manner of determining a time point to provide a notification. In operation 2105, the electronic device 101 may provide the notification to a first application identified by a first traffic descriptor corresponding to the first route selection descriptor at the determined time point. In operation 2107, the electronic device 101 may perform at least one operation for establishing a PDU session, based on identification of a network connection request from the first application. Accordingly, a time point at which multiple electronic devices transmit a PDU session establishment request message to a network may be distributed. In an example, when a time point at which a specific URSP rule is available is a first time point, there is a possibility that multiple electronic devices request a PDU session establishment request message from the network at substantially the same time. According to various embodiments, the electronic device 101 may configure a time point of providing a notification to an application, randomly (or so that multiple electronic devices have different values), thereby relieving the network from temporarily requesting a relatively large number of PDU sessions.

FIG. 21B is a flowchart illustrating an operating method of an electronic device according to various embodiments.

According to various embodiments, in operation 2111, the electronic device 101 (e.g., at least a part of the processor 120, the first communication processor 212, the second communication processor 214, or the integrated communication processor 260) may obtain a URSP rule including at least one traffic descriptor and at least one route selection descriptor. In operation 2113, the electronic device 101 may identify that an identified time and/or an identified place corresponds to first time information and/or first place information included in a first route selection descriptor. In operation 2115, the electronic device 101 may provide a notification to a first application identified by a first traffic descriptor corresponding to the first route selection descriptor. In operation 2117, the electronic device 101 may determine a time point for a PDU session establishment request, based on identification of a network connection request from the first application. For example, the electronic device 101 may determine the time point for the PDU session establishment request, based on an output value of a random function. For example, the electronic device 101 may determine the time point for the PDU session establishment request, based on a result of processing (e.g., hashing) at least one of IMEI, IMSI, a Phone Number, a MAC address, an IP address, or time information, and there is no limitation on a manner of determining a time point for a PDU session establishment request. In operation 2119, the electronic device 101 may perform at least one operation for establishing a PDU session at the determined time point. According to various embodiments, the electronic device 101 may configure a time point for a PDU session establishment request, randomly (or so that multiple electronic devices have different values), thereby relieving a network from temporarily requesting a relatively large number of PDU sessions.

According to various embodiments, an electronic device (e.g., the electronic device 101) may include at least one processor (e.g., at least a part of the processor 120, the first communication processor 212, the second communication processor 214, or the integrated communication processor 260) and a memory (e.g., the memory 130) connected electrically to the at least one processor and configured to store instructions executable by the at least one processor, wherein the instructions, when executed by the at least one processor, cause the electronic device to obtain a URSP rule including at least one traffic descriptor and at least one route selection descriptor, identify that a time identified by the electronic device and/or a place identified by the electronic device corresponds to first time information and/or first place information included in a first route selection descriptor among the at least one route selection descriptor, provide a notification to a first application identified by a first traffic descriptor among the at least one traffic descriptor corresponding to the first route selection descriptor, and perform, based on identification of a network connection request from the first application that received the notification, at least one operation for establishing a PDU session based on the first route selection descriptor corresponding to the first application.

According to various embodiments, the instructions are configured to, when executed by the at least one processor, cause the electronic device to, as at least a part of the performing of the at least one operation for establishing the PDU session based on the first route selection descriptor corresponding to the first application, based on the identification of the network connection request from the first application that received the notification, provide a UI corresponding to the notification, and perform the at least one operation for establishing the PDU session based on the first route selection descriptor corresponding to the first application, based on identification of the network connection request from the first application provided in response to identification of a command for establishing the PDU session through the UI.

According to various embodiments, the instructions are configured to, when executed by the at least one processor, cause the electronic device to, as at least a part of the providing of the UI corresponding to the notification, request additional information from an application server corresponding to the first application, and configure the UI by using the additional information received from the application server in response to the request.

According to various embodiments, the instructions are configured to, when executed by the at least one processor, cause the electronic device to, as at least a part of the performing of the at least one operation for establishing the PDU session based on the first route selection descriptor corresponding to the first application, based on the identification of the network connection request from the first application that received the notification, perform the at least one operation for establishing the PDU session based on the first route selection descriptor corresponding to the first application, based on identification of the network connection request from the first application provided in response to receiving the notification.

According to various embodiments, the instructions are configured to, when executed by the at least one processor, cause the electronic device to configure at least one event, each of which includes at least a part of a traffic descriptor, at least a part of a route selection descriptor, time information, and/or place information, by using at least a part of the at least one traffic descriptor and the at least one route selection descriptor of the URSP rule, and the at least one processor may be configured to, as at least a part of the identifying that the time identified by the electronic device and/or the place identified by the electronic device corresponds to the first time information and/or the first place information included in the first route selection descriptor among the at least one route selection descriptor, identify whether the time identified by the electronic device and/or the place identified by the electronic device corresponds to the time information and/or the place information of each of the at least one event.

According to various embodiments, the instructions are configured to, when executed by the at least one processor, cause the electronic device to, as at least a part of the configuring of the at least one event, configure at least a part of the at least one event corresponding to at least one second traffic descriptor including an AppID from among the at least one traffic descriptor of the URSP rule, and refrain from configuring an event corresponding to at least one third traffic descriptor which does not include the AppID from among the at least one traffic descriptor of the URSP rule.

According to various embodiments, the instructions are configured to, when executed by the at least one processor, cause the electronic device to, as at least a part of the configuring of the at least one event, configure at least a part of the at least one event corresponding to at least one second traffic descriptor which does not include security information from among the at least one traffic descriptor of the URSP rule, and refrain from configuring an event corresponding to at least one third traffic descriptor including the security information from among the at least one traffic descriptor of the URSP rule.

According to various embodiments, the instructions are configured to, when executed by the at least one processor, cause the electronic device to, as at least a part of the configuring of the at least one event, configure at least a part of the at least one event corresponding to at least one second route selection descriptor including time information and/or place information satisfying a specified condition from among the at least one route selection descriptor of the URSP rule, and refrain from configuring an event corresponding to at least one third route selection descriptor including time information and/or place information which does not satisfy the specified condition from among the at least one route selection descriptor of the URSP rule.

According to various embodiments, the instructions are configured to, when executed by the at least one processor, cause the electronic device to, as at least a part of the providing of the notification to the first application identified by the first traffic descriptor corresponding to the first route selection descriptor, provide the notification to the first application identified by the first traffic descriptor, based on a first priority corresponding to the first route selection descriptor being higher than a second priority corresponding to a fourth route selection descriptor corresponding to the time identified by the electronic device and/or the place identified by the electronic device.

According to various embodiments, the instructions are configured to, when executed by the at least one processor, cause the electronic device to, as at least a part of the providing of the notification to the first application identified by the first traffic descriptor corresponding to the first route selection descriptor, download the first application, based on the first traffic descriptor, to install the first application on the electronic device, and provide the notification to the first application.

According to various embodiments, the instructions are configured to, when executed by the at least one processor, cause the electronic device to, as at least a part of the downloading of the first application based on the first traffic descriptor to install the first application on the electronic device, provide a UI which inquires about whether the first application is downloaded, and based on identification of a download command of the first application through the UI, download the first application based on the first traffic descriptor.

According to various embodiments, the instructions are configured to, when executed by the at least one processor, cause the electronic device to, as at least a part of the providing of the notification to the first application identified by the first traffic descriptor corresponding to the first route selection descriptor, identify a time point of providing the notification, and provide the notification to the first application at the identified time point.

According to various embodiments, the instructions are configured to, when executed by the at least one processor, cause the electronic device to, as at least a part of the performing of the at least one operation for establishing the PDU session based on the first route selection descriptor corresponding to the first application, identify a time point to transmit a PDU session establishment request message based on the first route selection descriptor, and transmit the PDU session establishment request message at the identified time point.

According to various embodiments, an operating method of an electronic device may include obtaining a URSP rule including at least one traffic descriptor and at least one route selection descriptor, identifying that a time identified by the electronic device and/or a place identified by the electronic device corresponds to first time information and/or first place information included in a first route selection descriptor among the at least one route selection descriptor, providing a notification to a first application identified by a first traffic descriptor corresponding to the first route selection descriptor, and performing, based on identification of a network connection request from the first application that received the notification, at least one operation for establishing a PDU session based on the first route selection descriptor corresponding to the first application.

According to various embodiments, the performing of the at least one operation for establishing the PDU session based on the first route selection descriptor corresponding to the first application, based on the identification of the network connection request from the first application that received the notification, may include providing a UI corresponding to the notification, and performing the at least one operation for establishing the PDU session based on the first route selection descriptor corresponding to the first application, based on identification of the network connection request from the first application provided in response to identification of a command for establishing the PDU session through the UI.

According to various embodiments, the providing of the UI corresponding to the notification may include requesting additional information from an application server corresponding to the first application, and configuring the UI by using the additional information received from the application server in response to the request.

According to various embodiments, the performing of the at least one operation for establishing the PDU session based on the first route selection descriptor corresponding to the first application, based on the identification of the network connection request from the first application that received the notification, may include performing the at least one operation for establishing the PDU session based on the first route selection descriptor corresponding to the first application, based on identification of the network connection request from the first application provided in response to receiving the notification.

According to various embodiments, the providing of the notification to the first application identified by the first traffic descriptor corresponding to the first route selection descriptor may include providing the notification to the first application identified by the first traffic descriptor, based on a first priority corresponding to the first route selection descriptor being higher than a second priority corresponding to a second route selection descriptor corresponding to the time identified by the electronic device and/or the place identified by the electronic device.

According to various embodiments, the providing of the notification to the first application identified by the first traffic descriptor corresponding to the first route selection descriptor may include downloading the first application, based on the first traffic descriptor, to install the first application on the electronic device, and providing the notification to the first application.

According to various embodiments, an electronic device may include at least one processor, wherein the at least one processor is configured to obtain a URSP rule including at least one traffic descriptor and at least one route selection descriptor, obtain a network connection request for an event from a first application, and based on first time information and/or first place information included in a first route selection descriptor among the at least one route selection descriptor corresponding to a time identified by the electronic device and/or a place identified by the electronic device, the first route selection descriptor corresponding to a first traffic descriptor among the at least one traffic descriptor identified based on information included in the network connection request, perform at least one operation for establishing a PDU session based on the first route selection descriptor.

According to various embodiments, an electronic device may include at least one processor, wherein the at least one processor is configured to obtain a URSP rule including at least one traffic descriptor and at least one route selection descriptor, identify an inquiry from a first application, provide a response corresponding to the inquiry to the first application, based on first time information and/or first place information included in a first route selection descriptor among the at least one route selection descriptor corresponding to a time identified by the electronic device and/or a place identified by the electronic device, the first route selection descriptor corresponding to a first traffic descriptor among the at least one traffic descriptor identified based on information included in the inquiry, and based on identification of a network connection request from the first application that received the response, perform at least one operation for establishing a PDU session based on the first route selection descriptor corresponding to the first application.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
at least one processor; and
memory storing instructions that, when executed by the at least one processor, cause the electronic device to:
obtain a user equipment route selection policy (URSP) rule including at least one traffic descriptor and at least one route selection descriptor;
identify that a time identified by the electronic device and/or a place identified by the electronic device corresponds to first time information and/or first place information, included in a first route selection descriptor among the at least one route selection descriptor;
provide a notification to a first application identified by a first traffic descriptor among the at least one traffic descriptor corresponding to the first route selection descriptor; and
perform, based on identification of a network connection request from the first application that received the notification, at least one operation for establishing a protocol data unit (PDU) session based on the first route selection descriptor corresponding to the first application.

2. The electronic device of claim 1, wherein the instructions, when executed by the at least one processor, cause the electronic device to, as at least a part of the performing of the at least one operation for establishing the PDU session based on the first route selection descriptor corresponding to the first application, based on the identification of the network connection request from the first application that received the notification:
provide a user interface (UI) corresponding to the notification; and
perform the at least one operation for establishing the PDU session based on the first route selection descriptor corresponding to the first application, based on the identification of the network connection request from the first application provided in response to identification of a command for establishing the PDU session through the UI.

3. The electronic device of claim 2, wherein the instructions, when executed by the at least one processor, cause the electronic device to, as at least a part of the providing of the UI corresponding to the notification:
request additional information from an application server corresponding to the first application; and
configure the UI by using the additional information received from the application server in response to the request.

4. The electronic device of claim 1, wherein the instructions, when executed by the at least one processor, cause the electronic device to, as at least a part of the performing of the at least one operation for establishing the PDU session based on the first route selection descriptor corresponding to the first application, based on the identification of the network connection request from the first application that received the notification,
perform the at least one operation for establishing the PDU session based on the first route selection descriptor corresponding to the first application, based on the identification of the network connection request from the first application provided in response to receiving the notification.

5. The electronic device of claim 1, wherein the instructions, when executed by the at least one processor, cause the electronic device to configure at least one event, each of which includes at least a part of a traffic descriptor, at least a part of a route selection descriptor, time information, and/or place information, by using at least a part of the at least one traffic descriptor and the at least one route selection descriptor, of the URSP rule, and
wherein the at least one processor is configured to, as at least a part of the identifying that the time identified by the electronic device and/or the place identified by the electronic device corresponds to the first time information and/or the first place information included in the first route selection descriptor among the at least one route selection descriptor, identify whether the time identified by the electronic device and/or the place identified by the electronic device corresponds to the time information and/or the place information of each of the at least one event.

6. The electronic device of claim 5, wherein the instructions, when executed by the at least one processor, cause the electronic device to, as at least a part of the configuring of the at least one event:
configure at least a part of the at least one event corresponding to at least one second traffic descriptor including an AppID from among the at least one traffic descriptor, of the URSP rule; and
refrain from configuring an event corresponding to at least one third traffic descriptor which does not include the AppID from among the at least one traffic descriptor of the URSP rule.

7. The electronic device of claim 5, wherein the instructions, when executed by the at least one processor, cause the electronic device to, as at least a part of the configuring of the at least one event:
configure at least a part of the at least one event corresponding to at least one second traffic descriptor which does not include security information from among the at least one traffic descriptor of the URSP rule; and
refrain from configuring an event corresponding to at least one third traffic descriptor including the security information from among the at least one traffic descriptor of the URSP rule.

8. The electronic device of claim 5, wherein the instructions, when executed by the at least one processor, cause the electronic device to, as at least a part of the configuring of the at least one event:
configure at least a part of the at least one event corresponding to at least one second route selection descriptor including the time information and/or the place information satisfying a specified condition from among the at least one route selection descriptor of the URSP rule; and
refrain from configuring an event corresponding to at least one third route selection descriptor including the time information and/or the place information which does not satisfy the specified condition from among the at least one route selection descriptor of the URSP rule.

9. The electronic device of claim 1, wherein the instructions, when executed by the at least one processor, cause the electronic device to, as at least a part of the providing of the notification to the first application identified by the first traffic descriptor corresponding to the first route selection descriptor,
provide the notification to the first application identified by the first traffic descriptor, based on a first priority corresponding to the first route selection descriptor being higher than a second priority corresponding to a fourth route selection descriptor corresponding to the time identified by the electronic device and/or the place identified by the electronic device.

10. The electronic device of claim 1, wherein the instructions, when executed by the at least one processor, cause the electronic device to, as at least a part of the providing of the notification to the first application identified by the first traffic descriptor corresponding to the first route selection descriptor:
download and install the first application on the electronic device, based on the first traffic descriptor; and
provide the notification to the first application.

11. The electronic device of claim 10, wherein the instructions, when executed by the at least one processor, cause the electronic device to, as at least a part of the downloading of the first application based on the first traffic descriptor to install the first application on the electronic device:
provide a UI which inquires about whether the first application is downloaded; and
based on identification of a download command of the first application through the UI, download the first application based on the first traffic descriptor.

12. The electronic device of claim 1, wherein the instructions, when executed by the at least one processor, cause the electronic device to, as at least a part of the providing of the notification to the first application identified by the first traffic descriptor corresponding to the first route selection descriptor:
identify a time point of providing the notification; and
provide the notification to the first application at the identified time point.

13. The electronic device of claim 1, wherein the instructions, when executed by the at least one processor, cause the electronic device to, as at least a part of the performing of the at least one operation for establishing the PDU session based on the first route selection descriptor corresponding to the first application:
identify a time point to transmit a PDU session establishment request message based on the first route selection descriptor; and
transmit the PDU session establishment request message at the identified time point.

14. An operating method of an electronic device, the method comprising:
obtaining a user equipment route selection policy (URSP) rule including at least one traffic descriptor and at least one route selection descriptor;
identifying that a time identified by the electronic device and/or a place identified by the electronic device corresponds to first time information and/or first place information included in a first route selection descriptor among the at least one route selection descriptor;
providing a notification to a first application identified by a first traffic descriptor corresponding to the first route selection descriptor; and
performing, based on identification of a network connection request from the first application that received the notification, at least one operation for establishing a protocol data unit (PDU) session based on the first route selection descriptor corresponding to the first application.

15. The operating method of claim 14, wherein the performing of the at least one operation for establishing the PDU session based on the first route selection descriptor corresponding to the first application, based on the identification of the network connection request from the first application that received the notification, comprises:
providing a user interface (UI) corresponding to the notification; and
performing the at least one operation for establishing the PDU session based on the first route selection descriptor corresponding to the first application, based on identification of the network connection request from the first application provided in response to identification of a command for establishing the PDU session through the UI.

16. The operating method of claim 15, wherein the providing of the UI corresponding to the notification includes requesting additional information from an application server corresponding to the first application, and configuring the UI by using the additional information received from the application server in response to the request.

17. The operating method of claim 14, wherein the performing of the at least one operation for establishing the PDU session based on the first route selection descriptor corresponding to the first application, based on the identification of the network connection request from the first application that received the notification, includes performing the at least one operation for establishing the PDU session based on the first route selection descriptor corresponding to the first application, based on identification of the network connection request from the first application provided in response to receiving the notification.

18. The operating method of claim 14, wherein the providing of the notification to the first application identified by the first traffic descriptor corresponding to the first route selection descriptor includes providing the notification to the first application identified by the first traffic descriptor, based on a first priority corresponding to the first route selection descriptor being higher than a second priority corresponding to a second route selection descriptor corresponding to the time identified by the electronic device and/or the place identified by the electronic device.

19. The operating method of claim 14, wherein the providing of the notification to the first application identified by the first traffic descriptor corresponding to the first route selection descriptor includes downloading the first application, based on the first traffic descriptor, to install the first application on the electronic device, and providing the notification to the first application.

20. An electronic device comprising:
at least one processor; and
memory storing instructions, when executed by the at least one processor, cause the electronic device to:
obtain a user equipment route selection policy (URSP) rule including at least one traffic descriptor and at least one route selection descriptor;
obtain a network connection request for an event from a first application;
based on first time information and/or first place information included in a first route selection descriptor among the at least one route selection descriptor corresponding to a time identified by the electronic device and/or a place identified by the electronic device, the first route selection descriptor corresponding to a first traffic descriptor among the at least one traffic descriptor identified based on information included in the network connection request, perform at least one operation for establishing a protocol data unit (PDU) session based on the first route selection descriptor.
